(19) United States
(12) Patent Application Publication
(10) Pub. No.: US 2015/0379574 A1
(43) Pub. Date: Dec. 31, 2015

(54) Methods, Apparatuses, and Computer-Readable Media for Boosting Ad Scores Based on Location Proximity and/or Social Affinity

(71) Applicants: Neha Pattan, Mountain View, CA (US); Jennifer W. Lin, San Jose, CA (US)

(72) Inventors: Neha Pattan, Mountain View, CA (US); Jennifer W. Lin, San Jose, CA (US)

(73) Assignee: Google Inc.

(21) Appl. No.: 13/270,953

(22) Filed: Oct. 11, 2011

(51) Int. Cl. G06Q 30/02

(52) U.S. Cl. CPC G06Q 30/0261

(57) ABSTRACT

Methods, apparatuses, and computer-readable media for serving annotations are disclosed. When a contact of a user recommends an ad, the score of the ad may be boosted in an ad auction. The amount of boosting depends on location proximity and/or contact affinity. For location proximity, the closer the geographic location of the recommendation to the user, the greater the boost to the ad score. For contact affinity, the greater the affinity between the user and contact, the greater the boost to the ad score. Affinity may be measured by a weight value, which is determined by, for example, the frequency of calls, text, or views of the contact's information by the user.

### FIELD OF ENDEAVOR

Aspects of the present invention relate to methods, apparatuses, and computer-readable media to serve social annotations and improve the relevance of content being served. Aspects of the invention are useful in a variety of applications, including providing ads that are more relevant and meaningful to users. Specifically, aspects of the present invention relate to storing content recommendations such as ad recommendations made by a user's contacts and boosting, on the basis of location proximity or contact affinity, the likelihood of serving the recommended content.

### BACKGROUND

Internet-based advertising has had varying degrees of success. Advertising such as banner ads may be shown to visitors to a webpage. Banner ads, however, are sometimes ineffective. Ad viewers may ignore the banner ads because the ads are usually not tailored to appeal to the user. Ad viewers might not feel that the ad sends a message that is relevant to them. Because the message of the ad is not considered relevant by ad viewers, the ad suffers from a lower click-through rate. Ad viewers miss an opportunity to obtain a valuable service or product, and the advertiser loses a valuable opportunity to gain a customer.

As recognized by the inventors, increasing the relevance of the overall message of the ad is desired. In one approach, the content of the webpage that a user is viewing is used to choose an ad for a user. However, the message of the ad is still not tailored to appeal to the user. Such an approach only addresses the interests of the user at the moment that the user is viewing the webpage, and may not appeal strongly to the user. In light of such drawbacks, a better approach to delivering an advertising message that more strongly appeals to the user is desired.

### SUMMARY

In one aspect of the present invention, the invention includes an apparatus, including: one or more processors, a computer-readable medium coupled to the one or more processors having instructions stored thereon that, when executed by the one or more processors, cause the one or more processors to perform operations including: receiving a request for an advertisement from a client device associated with a first user, the advertisement request including a location of the first user and data indicative of the first user's identification; accessing one or more tables that associate an advertisement, a recommendation indication, a user identification of a recommending user making a recommendation indication for the ad, and a location at which the recommendation indication was made by the recommending user; determining that the recommending user is also a contact; increasing an ad score of one or more ads in response to the advertisement request based on the determination that the recommending user is also a contact and based on the location of the first user and the location at which the recommendation indication was made by the contact; and serving the one or more ads to the client device.

In a further aspect of the present invention, the computer-readable medium coupled to the one or more processors has further instructions stored thereon that, when executed by the one or more processors, cause the one or more processors to perform operations further including: annotating the selected one or more ads using a name of the first user, based on the data indicative of the first user's identification.

In a further aspect of the present invention, the computer-readable medium coupled to the one or more processors has further instructions stored thereon that, when executed by the one or more processors, cause the one or more processors to perform operations further including: maintaining an index of location records sorted by distance to the client device; reading, from the index, an index value indicating a location record associated with the location; and retrieving the location record from the location table based on the index value.

In a further aspect of the present invention, a least distance is computed by computing a distance from the location at which the recommendation indication was made to a location of the client device when sending the request for an advertisement; and wherein the one or more ads that are served includes an ad associated with the least distance.

In a further aspect of the present invention, a least distance is computed by computing a distance from the location at which the recommendation indication was made by the recommending user to a most recently known location of the client device; and wherein the one or more ads that are served includes an ad associated with the least distance.

In a further aspect of the present invention, increasing the ad scores of the one or more ads further comprises increasing the ad scores by a boost value inversely proportional to a computed distance from the recommending user to the location of the client device.

In a further aspect of the present invention, increasing the ad scores of the one or more ads further comprises increasing each of the ad scores based on multiple computed distances.

In a further aspect of the present invention, increasing the ad scores of the one or more ads further comprises increasing, by a weight value, an ad score of an ad recommended by the recommending user.

In a further aspect of the present invention, the one or more tables may include a recommendation data table and a social data table and/or a location data table; wherein the recommendation data table includes at least user ID, ad ID, and timestamp information; wherein the social data table includes at least user ID, contact ID, and weight information; and wherein the location data table includes at least user ID, location, and timestamp information.

In a further aspect of the present invention, the advertisements are also associated with contact data.

In a further aspect of the present invention, the advertisements are also associated with ad IDs.

In another aspect of the present invention, the invention includes a method performed by a data processing apparatus, including: receiving a request for an advertisement from a client device associated with a first user, the advertisement request including a location of the first user and data indicative of the first user's identification; accessing one or more tables that associate an advertisement, a recommendation indication, a user identification of a recommending user making a recommendation indication for the ad, and a location at which the recommendation indication was made by the recommending user; determining that the recommending user is also a contact; increasing an ad score of one or more ads in response to the advertisement request based on the determination that the recommending user is also a contact and based on the location of the first user and the location at which the recommendation indication was made by the contact; and serving the one or more ads to the client device.

In a further aspect of the present invention, the method further includes annotating the selected one or more ads using a name of the first user, based on the data indicative of the first user's identification.

In a further aspect of the present invention, the method further includes maintaining an index of location records sorted by distance to the client device; reading, from the index, an index value indicating a location record associated with the location; and retrieving the location record from the location table based on the index value.

In a further aspect of the present invention, the method further includes a least distance is computed by computing a distance from the location at which the recommendation indication was made to a location of the client device when sending the request for an advertisement; and wherein the one or more ads that are served includes an ad associated with the least distance.

In a further aspect of the present invention, the method further includes a least distance is computed by computing a distance from the location at which the recommendation indication was made by the recommending user to a most recently known location of the client device; and wherein the one or more ads that are served includes an ad associated with the least distance.

In a further aspect of the present invention, the method further includes increasing the ad scores of the one or more ads further comprises increasing the ad scores by a boost value inversely proportional to a computed distance from the recommending user to the location of the client device.

In a further aspect of the present invention, the method further includes increasing the ad scores of the one or more ads further comprises increasing each of the ad scores based on multiple computed distances.

In a further aspect of the present invention, the method further includes increasing the ad scores of the one or more ads further comprises increasing, by a weight value, an ad score of an ad recommended by the recommending user.

In a further aspect of the present invention, the method further includes the one or more tables may include a recommendation data table and a social data table and/or a location data table; wherein the recommendation data table includes at least user ID, ad ID, and timestamp information; wherein the social data table includes at least user ID, contact ID, and weight information; and wherein the location data table includes at least user ID, location, and timestamp information.

In a further aspect of the present invention, the method further includes the advertisements are also associated with contact data.

In a further aspect of the present invention, the method further includes the advertisements are also associated with ad IDs.

In a further aspect of the present invention, the invention includes a computer-readable medium coupled to one or more processors having instructions stored thereon that, when executed by the one or more processors, causes the one or more processors to perform operations including: receiving a request for an advertisement from a client device associated with a first user, the advertisement request including a location of the first user and data indicative of the first user's identification; accessing one or more tables that associate an advertisement, a recommendation indication, a user identification of a recommending user making a recommendation indication for the ad, and a location at which the recommendation indication was made by the recommending user; determining that the recommending user is also a contact; increasing an ad score of one or more ads in response to the advertisement request based on the determination that the recommending user is also a contact and based on the location of the first user and the location at which the recommendation indication was made by the contact; and serving the one or more ads to the client device.

In a further aspect of the present invention, the invention includes a method performed by a data processing apparatus, including: receiving a request for an advertisement from a client device associated with a first user, the advertisement request including a location of the first user and data indicative of the first user's identification; accessing one or more tables that associate, for each advertisement, contact data, a recommendation indication, an ad ID, user identification of a recommending user making a recommendation indication for the ad identified by the ad ID, and a location at which the recommendation indication was made by the recommending user; increasing an ad score of one or more ads in response to the advertisement request based on the location and the contact data; and serving the one or more ads to the client device.

In a further aspect of the present invention, the invention includes an apparatus, including: one or more processors, a computer-readable medium coupled to the one or more processors having instructions stored thereon that, when executed by the one or more processors, cause the one or more processors to perform operations including: presenting an advertisement to a user of the apparatus; receiving a recommendation indication for the presented advertisement from a user; receiving a location of the apparatus at a time substantially corresponding to when the recommendation indication was received; and logging the recommendation indication in association with the location, a user identification of the user making the recommendation, and an ads identification identifying the recommended ads.

In a further aspect of the present invention, the invention includes a computer-readable medium coupled to one or more processors having instructions stored thereon that, when executed by the one or more processors, cause the one or more processors to perform operations including: presenting an advertisement to a user of the apparatus; receiving a recommendation indication for the presented advertisement from a user; receiving a location of the apparatus at a time substantially corresponding to when the recommendation indication was received; and logging the recommendation indication in association with the location, a user identification of the user making the recommendation, and an ads identification identifying the recommended ads.

Further scope of applicability of the methods, apparatuses, and computer-readable storage mediums discussed will become apparent from the detailed description given hereinafter. However, it should be understood that the detailed description and specific examples, while indicating embodiments, are given by way of illustration only, since various changes and modifications within the spirit and scope of the concepts disclosed herein will become apparent to those skilled in the art from this detailed description.

### BRIEF DESCRIPTION OF THE DRAWINGS

The systems and methods discussed will become more fully understood from the detailed description given herein below and the accompanying drawings which are given by way of illustration only, and thus are not limitative, and wherein:

FIG. 1a is a block diagram illustrating a social annotation system in which ads with annotations regarding recommendations made by a user's contacts are boosted by location proximity, according to an embodiment.

FIG. 1b is a block diagram illustrating a social annotation system in which ads with annotations regarding recommendations made by a user's contacts are boosted by contact affinity, according to an embodiment.

FIG. 1c is a block diagram illustrating a social annotation system in which ads with annotations regarding recommendations made by a user's contacts are boosted by location proximity and contact affinity, according to an embodiment.

FIG. 2 is a flow diagram illustrating storing location data in tables after receiving a user recommendation, according to an embodiment.

FIG. 3 is a flow diagram illustrating storing contact data in tables after receiving a user recommendation, according to an embodiment.

FIG. 4 is a flow diagram illustrating storing both location data and contact data in tables after receiving a user recommendation, according to an embodiment.

FIG. 5a and FIG. 5b together form a flow diagram illustrating providing an annotated ad using the location data table, according to an embodiment.

FIG. 6a and FIG. 6b together form a flow diagram illustrating providing an annotated ad using the contact data table, according to an embodiment.

FIG. 7a and FIG. 7b together form a flow diagram illustrating providing an annotated ad using the both the location data and contact data table, according to an embodiment.

FIG. 8 is a flow diagram illustrating steps for boosting a score of an ad using location data, according to an embodiment.

FIG. 9 is a flow diagram illustrating boosting ad scores using social data, according to an embodiment.

FIG. 10 is a flow diagram illustrating boosting an ad score using both location data and social data, according to an embodiment.

FIG. 11 is a flow chart illustrating construction of annotation using the location data table, according to an embodiment.

FIG. 12 is a flow chart illustrating construction of annotation using the social data table, according to an embodiment.

FIG. 13 is a flow chart illustrating construction of annotation using the combination of the location data table and the social data table, according to an embodiment.

FIG. 14 illustrates a location data table, according to an embodiment.

FIG. 15 illustrates a social data table, according to an embodiment.

FIG. 16 illustrates a recommendation data table, according to an embodiment.

FIG. 17 is a block diagram illustrating another exemplary system upon which embodiments may be implemented.

The drawings will be described in detail in the course of the detailed description.

### DETAILED DESCRIPTION

The following detailed description refers to the accompanying drawings. The same reference numbers in different drawings identify the same or similar elements. Also, the following detailed description does not limit the concepts discussed. Instead, the scope of the concepts discussed herein is defined by the appended claims and equivalents thereof.

### Introduction

An ad displayed to a user on a device may be presented with an annotation. An annotation may be a communication indicating a recommendation previously made for the ad. Usually the recommendation is made by a social contact in the social graph of the person viewing the ad (hereafter “user”). The annotations may be written over or included within the ad. The annotations may be of the form social contact(s)+“recommended this ad”. The annotation indicates the recommendation made by the social contact(s). For example, an annotation may be “Alice recommended this ad”, where “Alice” is the name of a social contact of the user.

A social contact is an acquaintance of the user, and the user's social contacts may be recorded in a table in a storage. More than one social contact may be shown in the annotation. For example, the annotation may display as “Alice, Jill, and Bob recommended this ad”. In some embodiments, an image that is a photo or avatar of the social contact may be displayed with the annotation. In some embodiments, photos or avatars may be displayed in place of the names.

In one embodiment, the ad and annotation may be chosen on the basis of location proximity. In another embodiment, the ad and annotation may be chosen on the basis of contact affinity. In some embodiments, the ad in the annotation may be chosen on the basis of both location proximity and/or contact affinity.

For location proximity, social contacts make each recommendation while being physically present at a particular location which is called herein a “recommendation location”. The location proximity used by embodiments of the invention may be measured between the recommendation location and the location of a user being served content. Ads associated with recommendation locations that are computed to be geographically closer to the user at the time of selecting an ad for the user have a higher chance of being selected for display to the user. In one embodiment, the score of an ad is “boosted” if the ad is associated with the “least distant” recommendation. Boosting the score of an ad means increasing the score of the ad during an ad auction process that is performed after receiving an ad request. A recommendation is “least distant” if, considering all the recommendations made by the user's contacts, the recommendation is made at a location that is geographically nearest to the user. In some embodiments, after a least distant recommendation is used to boost an ad, the next least distant recommendation is used to boost either another ad or the same ad. In some cases, the score of an ad may be boosted due to the least distant recommendation, and then boosted again due to the next least distant recommendation made for the same ad. In some embodiments, multiple least distant recommendations are used to boost one or more ads.

For contact affinity, ads associated with recommendations made by social contacts who share a strong contact affinity with the user have a higher chance of being displayed to the user. “Contact affinity” generally means the frequency and/or volume of interactions between two people. Contact affinity may also include a measure of a bond between two people. In one embodiment, the score of an ad is boosted if the ad is recommended by a contact who shares a high social affinity with the user. In some embodiments, the score of an ad is boosted in proportion to the social affinity shared between the user and the contact.

In one embodiment, social affinity may be measured by a weight value. The weight value may be associated with each user-contact pair. For example, Bob and Alice call each other frequently and therefore share a weight value of 0.8. Bob rarely calls Kirk and therefore Bob and Kirk share a weight value of 0.2. In some embodiments, the weight value may be determined by the frequency that the user views the contact's information, or by the frequency with which the user texts the contact, or some combination of calls, texts, and views.

In some embodiments, for two people, the social affinity with the first person as a user and the second person as the contact may be different from the social affinity with the second person as the user and the first person as the contact. Such a situation may occur, for example, when the first person calls the second person often, but the second person does not call the first person often.

In some embodiments, both location proximity and contact affinity may be used to boost the score of an ad. In such embodiments, the score of the ad may be boosted first by location proximity, and second by contact affinity, or vice versa.

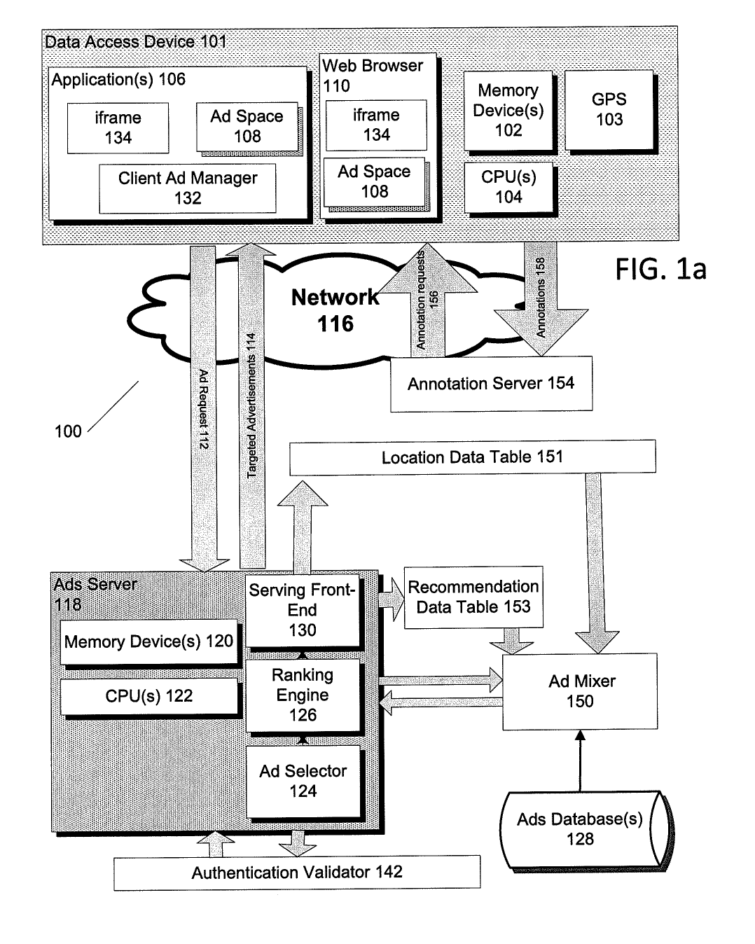

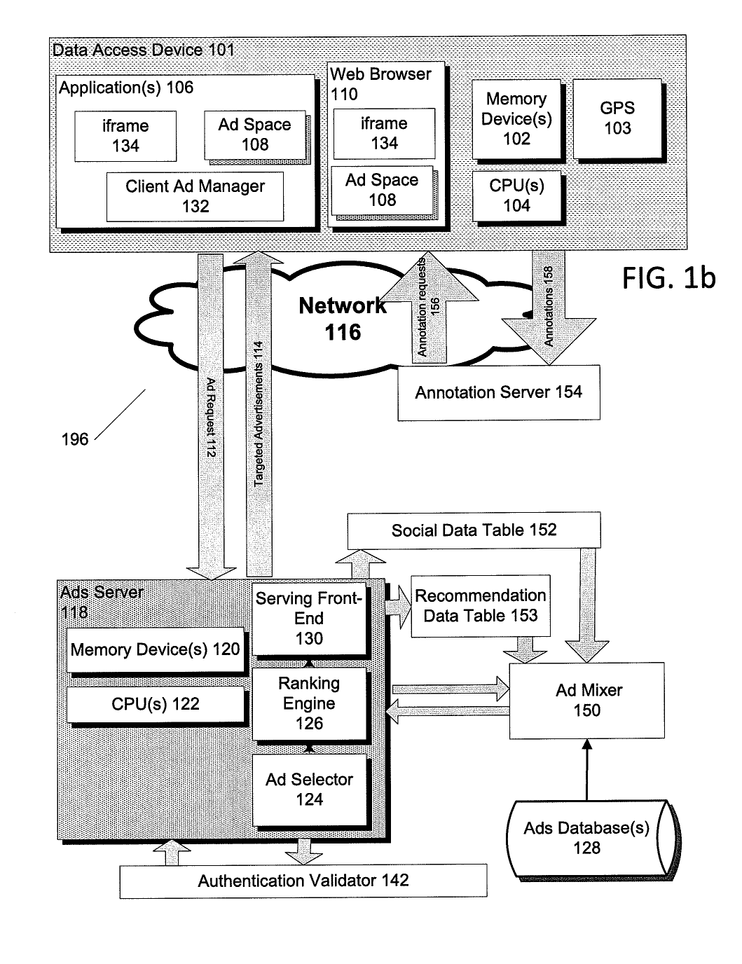

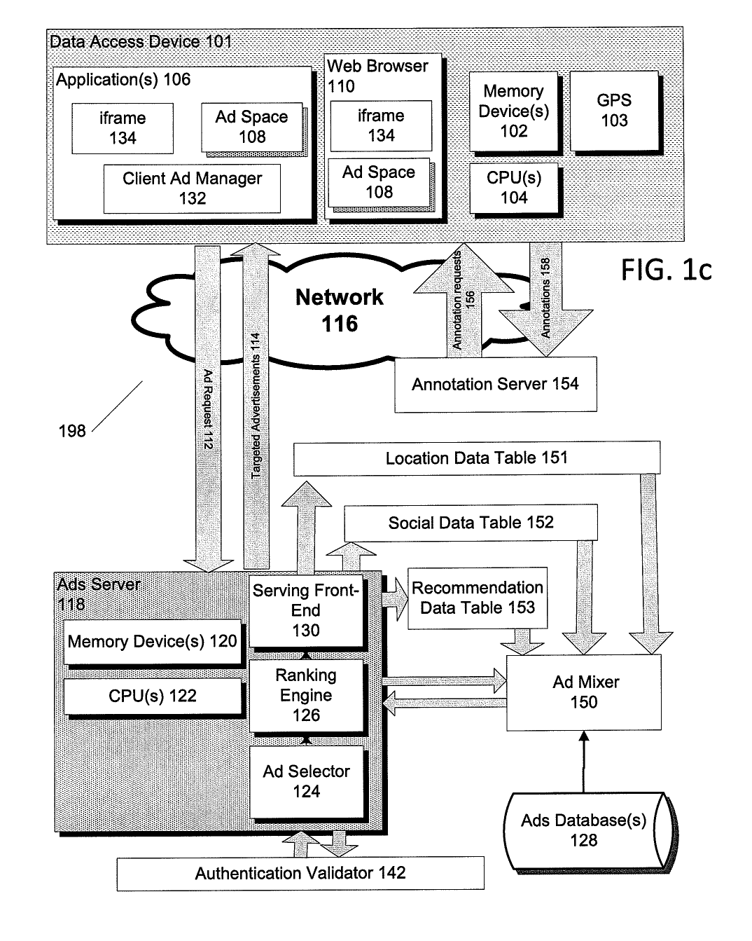

In some embodiments, an annotation is constructed on the basis of the least distant recommendation available for a selected ad and displayed with the ad. An ad with a boosted score may be annotated using the least distant recommendation. Because the ad is annotated using the name(s) of one or more social contacts of the user on the basis of location proximity and/or social affinity, the message of the ad with the annotations, as a whole, more strongly appeals to the user. The boosting of ad scores and construction of relevant annotations increases the relevance of the ad and annotation combination to the user. The annotations are constructed and served to applications and web browsers by a social annotation system such as the social annotation system described with respect to FIG. 1 below.

### Structural Overview

FIG. 1a, FIG. 1b, and FIG. 1c are block diagrams illustrating social annotation system 100, 196, and 198 in which ads with annotations regarding recommendations made by a user's contacts are boosted by location proximity and/or contact affinity, according to various embodiments. The annotations may be served to an application or a web browser, in response to a request for an ad from the application or the web browser. FIG. 1a, FIG. 1b, and FIG. 1c illustrate modules of the social annotation systems and some of the communications sent between the modules when an ad request is received from an application or from a web browser.

FIG. 1a is a block diagram illustrating a social annotation system in which ads with annotations regarding recommendations made by a user's contacts are boosted by location proximity, according to an embodiment. FIG. 1b is a block diagram illustrating a social annotation system in which ads with annotations regarding recommendations made by a user's contacts are boosted by contact affinity, according to an embodiment. FIG. 1c is a block diagram illustrating a social annotation system in which ads with annotations regarding recommendations made by a user's contacts are boosted by location proximity and contact affinity, according to an embodiment.

An embodiment of a mobile data access device 101 which is operated by the user may include a mobile telephone, a mobile handheld device, a media tablet device, netbook, notebook computer, GPS device, media player device, or some combination thereof or variation thereof. Mobile data access device 101 is hereafter referred to as “client” 101.

Client 101 may include one or more memory devices 102 for storing applications, application data, webpages, images, audio and/or video, device settings and/or preferences, and other information relevant to the operation, use, and potential user(s) of the device. Client 101 may also include one or more processors 104 to process the information and execute the applications stored in the memory device(s) 102. Variations of memory 102 and processor 104 devices may include magnetic, electronic, and/or optical devices and/or combinations thereof.

Some variations of client 101 may include a display screen (not shown) and/or a speaker (not shown). Other variations of a client may include signal output paths such as wired or wireless connections to external audio and/or video devices such as docking stations, earphones, near field communication devices, external displays, and other similar information presentation devices. Client 101 may also include a global positioning system (GPS) unit 103. The GPS unit 103 allows various applications and modules executing on client 101 to obtain data indicating the physical location of the user. Although at any given moment a user may be separated from a client device by a distance, for the purposes of the specification, the location of the client device and the user operating the client device may be considered to be the same.

Client 101 may include one or more applications 106. Some variations of applications 106 may include designated ad space 108 for the display of advertisements related to an application or the content/information presented or processed therein. Client 101 may also include one or more web browser tools 110 for viewing and interacting with webpages via a wired or wireless internet connection and/or via a mobile data exchange connection such as cellular, optical, near field communication, or some combination thereof Some variations of a web browser 110 may also include a designated ad space 108 for the display of advertisements related to webpage content, search results, web-based email, map information, and/or geo-temporal factors. In some embodiments, the web browser 110 is an application that is one example of application 106. In such embodiments, web browser 110 operates in a manner similar to other applications with respect to various embodiments of the invention.

Client 101 may submit advertisement requests 112 and receive served advertisements 114 via a communication network 116 such as the internet, a public, private, wired, and/or wireless local area network (LAN) or wide area network (WAN), a cellular communication network, telephone lines, radio-frequency networks, hard-wired connections, and/or combinations thereof. The ad requests 112 and served advertisements 114 may go to and from an ads server 118. In some embodiments, the ad request 112 may include encrypted identification information. The encrypted identification information may be a limited ID cookie, which is a cookie containing an encrypted unique identifier for the user. In some embodiments, the encrypted identification information may also be a non-limited identification cookie containing an encrypted unique identifier for the user. In some embodiments, the non-limited identification cookie can be used for more than a limited set of access capabilities. The specific contents of the non-limited identification cookie could be anything: random ID mapped with the user's ID in the backend, an encrypted user ID or some other function of random ID+timestamp+user ID, etc.

In yet other embodiments, the encrypted identification information may be an identifier that is encrypted. In some embodiments, the advertisements 114 may include annotations which are sent to client 101 for display. In some embodiments, the served ads 114 are sent over HTTP and the annotations are served over a secure HTTP connection (HTTPS).

An embodiment of an ads server 118 may be equipped with one or more memory devices 120 for storing information and one or more processors 122 for performing data processing operations. The embodiment shown is also equipped with an ad selector 124 and an optional ranking engine 126 that selects and optionally ranks ads from an ads database 128, and a serving frontend 130 that delivers the advertisement via network 116 to client 101.

In some embodiments, a client ad manager 132 may be compiled with the application 106 and become embedded within application 106. Client ad manager 132 thus may form an integral part of application 106. The client ad manager 132 manages advertising for application(s) 106, including sending requests for advertisements to ads server 118 and receiving ads from ads server 118. In other embodiments, client ad manager 132 may not be part of application 106, and may be part of web browser 110, or may be a separate module or component of client 101. In some embodiments, client ad manager 132 also manages advertising for web browser 110. In such embodiments, a client ad manager for web apps may run in a separate process space and have access to separate cookie jars.

In some embodiments, application(s) and/or web browser 110 includes an iframe 134 sent from ads server 118. The iframes depicted in FIG. 1 faun part of an embodiment in which ads server 118 sends an iframe 134 to client 101 in response to an ad request. The iframe 134 requests annotations and receives annotations for display to the user.

Ads server 118 may send the encrypted identification information to an authentication validator 142 to obtain user IDs. In an embodiment, a user ID is a unique value that identifies a user or a social contact in a social network. For example, the user ID may be a long integer. The user ID may be the social networking ID of the user or social contact. No two users or social contacts may have the same user ID.

One such example of encrypted identification information is the limited ID cookie. The limited ID cookie is a cookie, created by a limited ID cookie generator server, that contains an encrypted social networking ID (such as the user ID) from the user's social networking account. Each limited ID cookie is an encrypted cookie containing user ID data. Client 101 may store a copy of limited ID cookie received from a limited ID cookie generator server (not depicted in FIG. 1). The limited ID cookie is considered “weak” because the limited ID cookie cannot be decrypted by other third party services or applications and can be used only for social ad targeting. In some embodiments, the limited ID cookie may be used to keep track of user presence in social networks. The limited ID cookie may also include a timestamp and have a limited lifetime.

In some embodiments, as a security measure, only a specially designated server, authentication validator 142, may decrypt the limited ID cookie and retrieve the user ID that is stored inside the limited ID cookie. If an unauthorized party gains access to the limited ID cookie, the potential harm to the user is limited to social ad targeting using the social networking ID. Through the use of the limited ID cookies, the use of a more generalized, non-limited identification cookie that may allow for all types of access and transactions for the user is unnecessary for serving annotations. Thus, the user need not expose other more powerful social networking identification cookies, and because the limited ID cookie is only useful for social ad targeting and may expire, the damage that may occur due to unauthorized access of the limited ID cookie is limited.

An embodiment may include an ad mixer 150 that selects an ad to send to ads server 118. In some embodiments, ad mixer 150 may be part of ads server 118. In some embodiments, the functions of ad mixer 150 may be implemented within ranking engine 126 and/or ad selector 124. In some embodiments, ad mixer 150 retrieves records from a location data table 151, a social data table 152, and a recommendation data table 153 to boost ads in ads scoring on the basis of location proximity and/or social affinity. One or more modules or components may log recommendation indicators such as recommendation data records into the recommendation data table. In some embodiments, the ad that ad mixer 150 selects for sending to ads server 118 may be affected by information retrieved from the location data table 151, social data table 152, and recommendation data table 153.

An embodiment may also include authentication validator 142. In some embodiments, ad server 119 may send encrypted identification information to authentication validator 142, and receive a user ID from authentication validator 142. In some embodiments, the encrypted identification information is a limited ID cookie. Authentication validator 142 decrypts the encrypted identification information and provides the user ID that is stored in the encrypted identification information to ads server 118. In some embodiments, authentication validator 142 decrypts the encrypted identification information and provides the user ID that is stored in the encrypted identification information to any module or other requester that requests the user ID.

An embodiment may also include an annotation server 154. Annotation server 154 constructs and serves annotations to client 101. When ads server 118 receives a request from client 101, in an embodiment, ads server 118 sends an ad and an iframe 134 to client 101. The iframe 134 is installed on client 101, on the application or web browser that requested the ad. Iframe 134 sends annotation requests 156 to annotation server 154. Annotation server 154 retrieves records from the location data table 151, social data table 152, and recommendation data table 153 to construct annotations 158 that are sent to client 101.

Some modules or communications that may be present in the embodiments of FIG. 1a, FIG. 1b, and FIG. 1c are not depicted in the figures for simplicity of illustration. For example, one or more cron jobs are not depicted in the figures.

### Functional Overview

In an embodiment, in social annotation system 100, recommendation records, social data records, and/or location data records are created when a user recommends an ad. Any one of or any combination of the three sets of records may be used to boost ads according to location proximity and/or contact affinity.

In an embodiment, for location proximity boosting, when ads server 118 determines the ad that is to be sent to client 101, ads server 118 uses the location data to boost the scores of those ads that were recommended at a location closest to the user of the client. In other words, the least distant location where a recommendation is made for an ad is used to boost the score for the ad. In some embodiments, multiple ads may be boosted, if the multiple ads all have the least distant locations where recommendations are made.

In an embodiment, for contact affinity boosting, ads server 118 uses the social data to boost the scores of those ads that were recommended by a person who is a contact of the user. In some embodiments, multiple ads may be boosted based on contact affinity.

In an embodiment, for the combination of location proximity and contact affinity boosting, ads server 118 uses the location data in the social data to boost the scores of those ads that were recommended by a person associated with the least distant recommendation and is also a contact of the user.

The terms “advertisement” and “ad” are interchangeable as used in the present patent specification. The terms “identification” and “ID” are interchangeable as used in the present patent specification.

### Storing Location Data in Tables after Receiving a User Recommendation

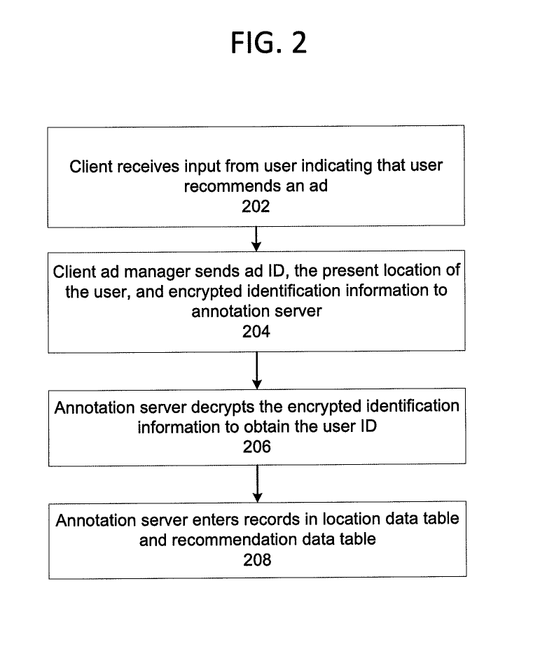

FIG. 2 is a flow diagram illustrating storing location data in tables after receiving a user recommendation, according to an embodiment. The steps of FIG. 2 may initiate when a user is viewing an ad that has been displayed to the user. The ad may be displayed at a display location such as ad space 108.

In step 202, client 101 receives input from the user indicating that the user recommends an ad. The input received may indicate that the user has clicked on a recommendation control displayed on top of or with the ad.

In step 204, client ad manager 132 sends an ad ID, a present location of the user, and encrypted identification information to annotation server 154. The encrypted identification information may be a limited ID cookie. The ad ID is the unique identifier for the ad that the user has clicked on. Client 101 may obtain the present location of the user from known methods such as a global positioning satellite signal via GPS 103 or through cell phone tower triangulation. In some embodiments, client 101 may also examine the IP address assigned to client 101 to determine the location of the client device. The limited ID cookie contains a user ID that identifies, to the annotation server 154, the user that has clicked on the ad.

In step 206, annotation server 154 decrypts the encrypted identification information to obtain a user ID. In an embodiment, annotation server 154 may decrypt a limited ID cookie to obtain the user ID. Annotation server 154 sends the limited ID cookie to authentication validator 142 to decrypt the limited ID cookie, in order to obtain the user ID. In other embodiments, annotation server 154 sends a non-limited identification cookie to authentication validator 142 in order to obtain the user ID.

In step 208, annotation server 154 enters records in the location data table 151 and the recommendation data table 153. In an embodiment, annotation server 154 enters a record into the location data table 151 that includes the user ID, the location, and the timestamp. The timestamp is the time at which the user clicked on the recommendation control. The location column stores the location at which the user clicked on the recommendation control. In some embodiments, the location column may contain protocol buffer with fields for street, city/zip code, country, latitude, and longitude. If the user recommendation from the user input has latitude/longitude data, then the ad server can convert the latitude/longitude to populate the rest of the fields in the location protocol buffer. If the user recommendation from the user input only has an IP address, then the ad server can convert the IP address to a city/zip code or country. In some embodiments, converting the IP address to the other fields may not be possible with high accuracy because more than one mobile device (at a distinct location) usually has the same IP address. In some embodiments, information from different wireless access points and networks is also used to get location information which is then sent to a geocoder to obtain street, city, zip, etc.

Annotation server 154 also enters a record into the recommendation data table 153 that includes a user ID, and ad ID, and a timestamp. The user ID of the user that clicked on the recommendation control is stored in the user ID column. The ad ID of the ad that was clicked on by the user is stored in an ad ID column. A timestamp representing the time at which the user clicked on the recommendation control is stored in the timestamp column.

### Storing Contact Data in Tables after Receiving a User Recommendation

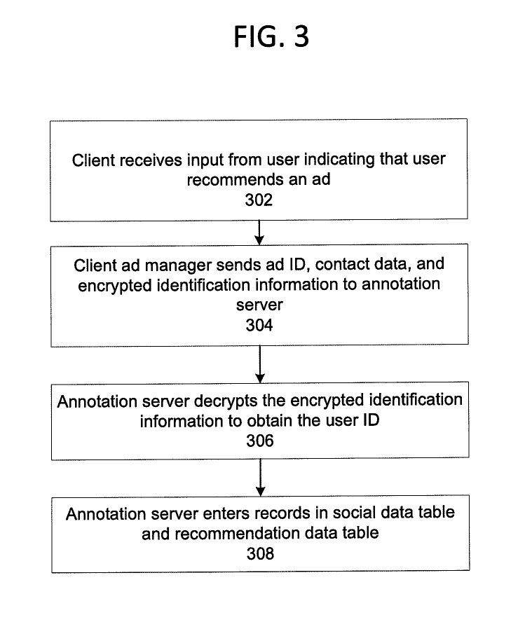

FIG. 3 is a flow diagram illustrating storing contact data in tables after receiving a user recommendation, according to an embodiment. The steps of FIG. 3 may initiate when a user is viewing an ad that has been displayed to the user. The ad may be displayed at a display location such as ad space 108.

In step 302, client 101 receives input from the user indicating that the user recommends an ad. The input received may indicate that the user has clicked on a recommendation control displayed on top of or with the ad.

In step 304, client ad manager 132 sends contact data, ad ID, and encrypted identification information to annotation server 154. The encrypted identification information may be a limited ID cookie. In some embodiments, client ad manager may also send a present location of the user. In some embodiments, client ad manager may also send non-limited identification cookie or some other permanent identifier to annotation server 154. The limited ID cookie, permanent identifier, or non-limited identification cookie contains a user ID that identifies, to the annotation server 154, the user that has clicked on the ad. The ad ID is the unique identifier for the ad that the user has clicked on.

Client ad manager 132 sends contact data for the user that includes a list of the names of friends in a contact application. The contact data may also include the frequency of calls, texts, or views of contacts from the contact application. Such a contact application may be, for example, a personal phone book directory for a phone application. In some embodiments, client ad manager may send a request to a contacts application for contact and history information. In some embodiments, an application programming interface may be used on some platforms to enable calling routines that retrieve the name, e-mail address, call history, and other information of contacts. In some embodiments, software that provides an Internet VoIP or other P2P service may also allow access to call history, etc. [INVENTORS: PLEASE CONFIRM] In some embodiments, the call history may be read from a database.

In some embodiments, client ad manager 132 may encrypt and send call, text, and view history of the user to either the annotation server 154 or a front end module (not depicted in FIG. 1). The front end module or annotation server 154 may decrypt the call history information and write the information into a log file. A cron job can read the call history logs and compute weights for the social data table. In some embodiments, annotation server 154 or the front end module computes the weights and enters the weights into the social data table without using a cron job.

In step 306, annotation server 154 decrypts the encrypted identification information to obtain the user ID. In an embodiment, annotation server 154 sends a limited ID cookie to authentication validator 142 to decrypt the limited ID cookie, in order to obtain the user ID. In some embodiments, annotation server 154 sends a non-limited identification cookie to a decryption server to decrypt the cookie, in order to obtain a user ID.

In step 308, annotation server 154 enters records in the social data table 152 and the recommendation table 153. For the social data table 152, annotation server 154 enters the user ID of the user in the user ID column, the user ID of the contact (also called “contact ID”) in the contact ID column, and a weight in the weight column. The weight value may be determined based on various interactions between the user and the contact. The timestamp may be the time at which the user clicked on the recommendation control.

In some embodiments, the call, view, and/or text history of the user and contact may be used to determine or update the weight value. In an embodiment, if the user calls the contact often, then the weight value of the contact may be set at a higher value according to some formula. If the user does not call the contact often, then the weight value of the contact may be set at a lower value. For example, if the user calls the contact every day, then the weight value may be set at 0.7. If the user calls the contact only once a month, then the weight value may be set at 0.3. In some embodiments, if the user has very lengthy conversations with the contact, then the weight is also increased accordingly. For example, if Bob calls Alice and talks to Alice every day for a few hours, then the weight between Alice and Bob can be set to 0.9, which is a higher value that reflects the greater social affinity between Bob and Alice. In some embodiments, if a first person calls a second person very often, but the second person does not reciprocate and almost never calls the first person, then the weight values may be different between the first person and the second person. For example, if only Bob calls Alice and Alice does not call Bob, then, for Bob, the weight with Alice in a contact ID column may be a high value such as 0.8. However, for Alice, the weight with Bob in a contact ID column may only be 0.1.

In an embodiment, if the user sends text messages to the contact often, then the weight value for the contact may be set at a higher value, such as 0.9. If the user does not send text messages to the contact very often, then the weight value of the contact may be set at a lower value, such as 0.2. In some embodiments, if a first person sends a text message to a second person very often, but the second person does not reciprocate by sending back text messages, then the weight values may be different between the first person and the second person. For example, if only Bob sends text messages to Alice and Alice does not send text messages to Bob, then, for Bob, the weight with Alice in the contact ID column is a high value such as 0.8. However, for Alice, the weight with Bob in a contact ID column is only 0.1.

In an embodiment, if the user views a contact profile of the contact often, then the weight value of the contact may be set at a higher value, such as 0.9. If the user almost never views the contact profile of the contact, then the weight value of the contact may be set at a lower value, such as 0.1.

In some embodiments, a system administrator may set the policy that calls are valued more than text messages, because when a user calls a contact, it means that the user cares enough about the contact to spend some time on a telephone conversation with the contact. A system administrator may set the policy that text messages are not weighted as highly as voice calls, because the user most likely just wants to avoid a conversation, and instead send a succinct message to the contact. It is likely that a short, to the point, text message to the contact indicates that the user simply wants to communicate the message without engaging in an extended conversation. For example, if Bob calls Alice very often, then the weight value for Alice as a contact may be 0.8. However, if Bob sends text messages to Alice without ever calling Alice, then the weight value for Alice as a contact may be only 0.2.

In some embodiments, a person is assigned a weight just because the person is in a user's contact list. As an example, annotation server 154 may enter a weight of 0.8 for a contact if the contact is listed in the user's contact list from a phone contacts application. A contact list is a list of friends of the user, and each person listed in the contact list may have the weight of 0.8 assigned in the social data table. Thus, if Bob is in Alice's contact list, then, in the example embodiment, Bob has a weight of 0.8. Annotation server 154 may enter the user ID for “Alice” as the user ID, Bob's user ID as the contact ID, and a weight of 0.8 for Bob. If the contact is already in the social data table 152, then annotation server 154 may overwrite the record for the contact with an updated weight value.

Annotation server 154 also enters a record into the recommendation data table 153 that includes a user ID, and ad ID, and a timestamp. The user ID of the user that clicked on the recommendation control is stored in the user ID column. The ad ID of the ad that was clicked on by the user is stored in an ad ID column. A timestamp representing the time at which the user clicked on the recommendation control is stored in the timestamp column.

### Storing Location Data and Social Data in Tables after Receiving a User Recommendation

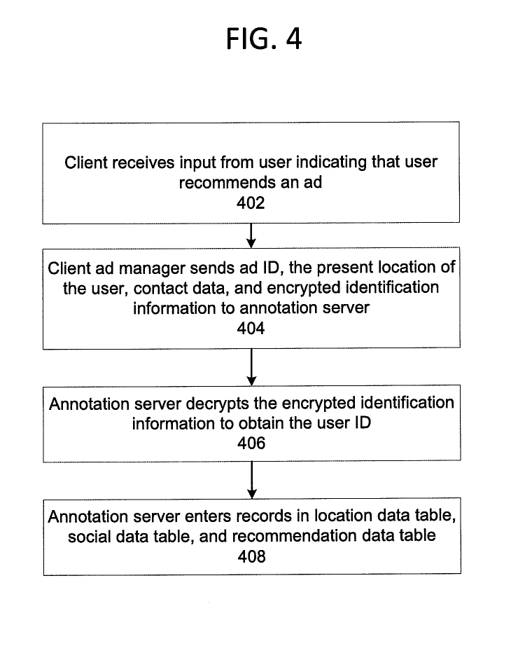

FIG. 4 is a flow diagram illustrating storing location data and social data in tables after receiving a user recommendation, according to an embodiment. The steps of FIG. 4 may initiate when a user is viewing an ad that has been displayed to the user. The ad may be displayed at a display location such as ad space 108.

In step 402, client 101 receives input from the user indicating that the user recommends an ad. The input received may indicate that the user has clicked on a recommendation control displayed on top of or with the ad.

In step 404, client ad manager 132 sends an ad ID, a present location of the user, and encrypted identification information to annotation server 154. The encrypted identification information may be a limited ID cookie, a non-limited identification cookie, or an encrypted identifier. The ad ID is the unique identifier for the ad that the user has clicked on. Client 101 may obtain the present location of the user from known methods such as a global positioning satellite signal via GPS 103 or through cell phone tower triangulation. The encrypted identification information contains a user ID that identifies, to the annotation server 154, the user that has clicked on the ad.

In step 406, annotation server 154 decrypts the encrypted identification information to obtain a user ID. In an embodiment, annotation server 154 may decrypt a limited ID cookie, a non-limited identification cookie, or some other encrypted identifier to obtain the user ID. Annotation server 154 sends the encrypted identification information to authentication validator 142 to decrypt the encrypted identification information, in order to obtain the user ID.

In step 408, annotation server 154 enters records in the location data table 151, social data table 152, and the recommendation data table 153. In an embodiment, annotation server 154 enters a record into the location data table 151 that includes the user ID, the location, and the timestamp. In an embodiment, annotation server 154 enters a record in social data table 152 that includes the user ID of the user that clicked on the recommendation control into the user ID column, the user ID of one or more contacts of the user into the content ID column, and a weight for each of the contacts. The timestamp is the time at which the user clicked on the recommendation control.

A location column in the location data table 151 may store the location at which the user clicked on the recommendation control. In some embodiments, the location column may contain protocol buffer with fields for street, city/zip code, country, latitude, and longitude. If the user recommendation from the user input has latitude/longitude data, then the ad server can convert the latitude/longitude to populate the rest of the fields in the location protocol buffer. If the user recommendation from the user input only has an IP address, then the ad server can convert the IP address to a city/zip code or country. In some embodiments, converting the IP address to the other fields may not be possible with high accuracy because more than one mobile device (at a distinct location) usually has the same IP address.

Annotation server 154 also enters a record into the recommendation data table 153 that includes a user ID, and ad ID, and a timestamp. The user ID of the user that clicked on the recommendation control is stored in the user ID column. The ad ID of the ad that was clicked on by the user is stored in an ad ID column. A timestamp representing the time at which the user clicked on the recommendation control is stored in the timestamp column.

### Providing an Ad and Annotation in Response to an Ad Request Using Location Data Table

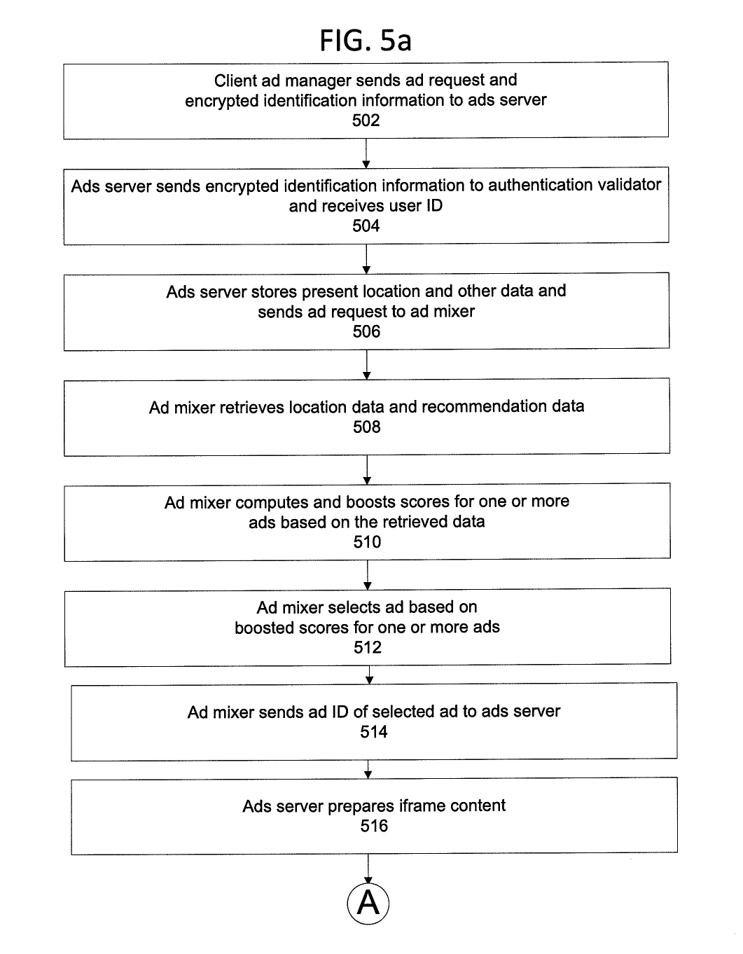

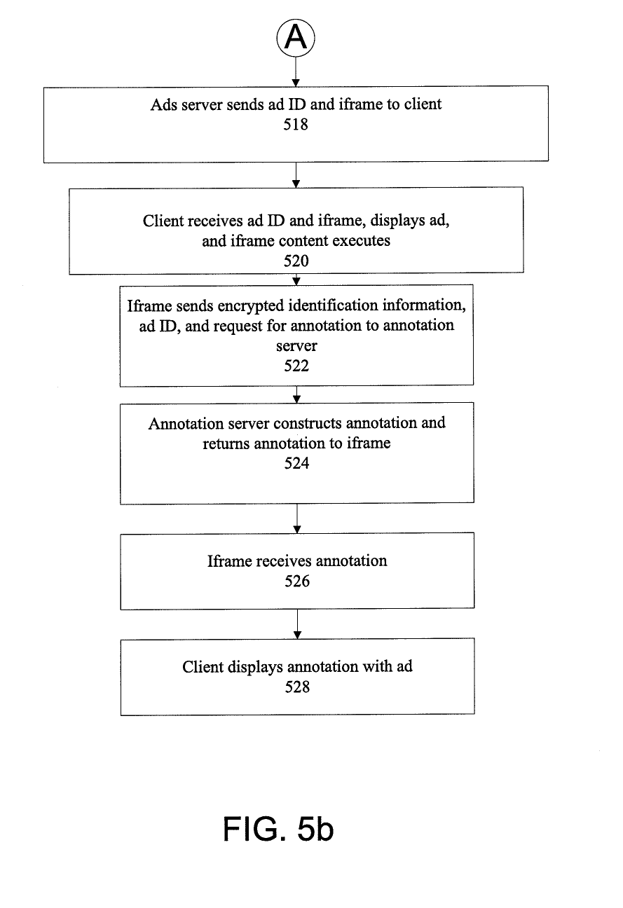

FIG. 5a and FIG. 5b together form a flow diagram illustrating providing an annotated ad using the location data table, according to an embodiment.

In step 502, client ad manager 132 sends ad request and encrypted identification information to ads server 118. Such encrypted identification information may be, for example, a non-limited identification cookie, a limited ID cookie, or some other identifier. Client ad manager 132 manages sending ad requests to ads server 118 and receiving ad requests from ads server 118. In an embodiment, the limited ID cookie board or the non-limited identification cookie contains an encrypted user ID that identifies the user that will be viewing the ad received from ads server 118. Client ad manager 132 may also send the current location of the user to ads server 118. Client 101 may obtain the current location of the client device using a global positioning system or cell phone tower triangulation, and client ad manager 132 sends the current location to the ads server. In some embodiments, client 101 may also obtain the current location of the client device by examining the IP address of the client device.

In some embodiments, client ad manager 132 may send encrypted location information to a front end module or ads server 118. The front end module or ads server 118 may decrypt the encrypted location information and write the information into a log file. A cron job can read the encrypted location information logs and enter the data in the location data table.

In step 504, ads server 118 sends the encrypted identification information to authentication validator 142 and receives a user ID. For example, ads server 118 may send a limited ID cookie or a non-limited identification cookie to authentication validator 142 and receive a user ID from the authentication validator 142. In some embodiments, authentication validator 142 is the only module with the capability to decrypt the encrypted identification information and extract the user ID. This adds a level of protection to the security of the encrypted identification information.

In step 506, ads server 118 stores the present location of the user and other data and sends ad request to ad mixer 150. In some embodiments, the stored location information may be used the next time the distance between the location of the user and location of a recommendation made by the user's contact is determined. The stored location information may be used as a most recently known location of the user. In some embodiments, the location stored may contain protocol buffer with fields for street, city/zip code, country, latitude, and longitude. If the ad request has latitude/longitude data, then the ad server can convert the latitude/longitude to populate the rest of the fields in the location protocol buffer. If the ad request only has an IP address, then the ad server can convert the IP address to a city/zip code or country. In some embodiments, converting the IP address to the other fields may not be possible with high accuracy because more than one mobile device (at a distinct location) usually has the same IP address.

In step 508, ad mixer 150 retrieves location data and recommendation data. Ad mixer 150 retrieves the data from the location table and recommendation table. Some of the data retrieval may be performed by ad mixer 150 as part of step 510, during the computing and score boosting process. The data may also be retrieved and cached for computation at ad mixer 150, in order to increase performance for step 510.

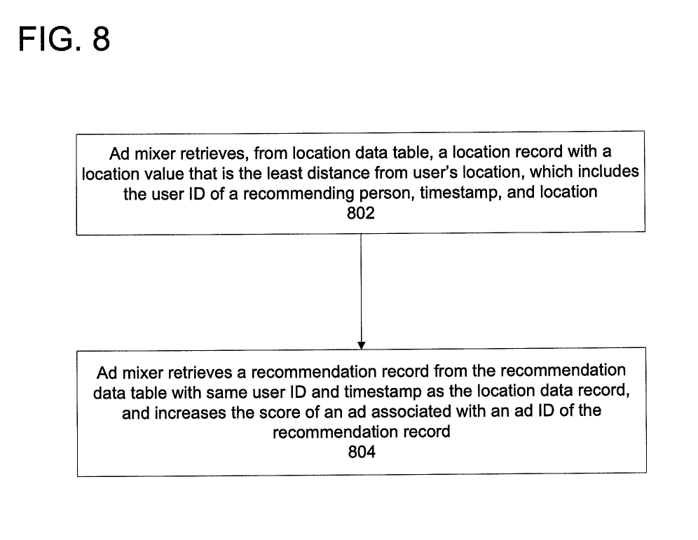

In step 510, ad mixer 150 computes and boosts scores for one or more ads based on the retrieved data. Ad mixer 150 uses the retrieved location data and recommendation data to boost scores of some ads. Ad mixer 150 may also use an index of sorted location data in order to efficiently determine the nearest locations associated with recommendations by contacts. FIG. 8 provides additional detail regarding the combination of steps 508 and 510.

In step 512, ad mixer 150 selects an ad based on boosted scores for one or more ads. Ad mixer 150 selects the ad with highest score, after boosting scores for the ads.

In step 514, ad mixer 150 sends an ad ID of the selected ad to ads server 118.

In step 516, ads server 118 prepares iframe content. Ads server 118 may create content for display by iframe 134 that will be sent to client 101.

In step 518, ads server 118 sends ad ID and iframe content to client 101.

In step 520, client 101 receives ad ID and iframe content, displays ad, and the iframe content executes within an inline frame on client 101. The iframe content executes in order to send an annotation request to annotation server 154 and receive an annotation from the annotation server 154.

In step 522, iframe 134 sends encrypted identification information, ad ID, and request for annotation to annotation server 154. The encrypted identification information may be a limited ID cookie, a non-limited identification cookie, or an encrypted identifier. The iframe communicates with annotation server 154 to request an annotation and receive the annotation.

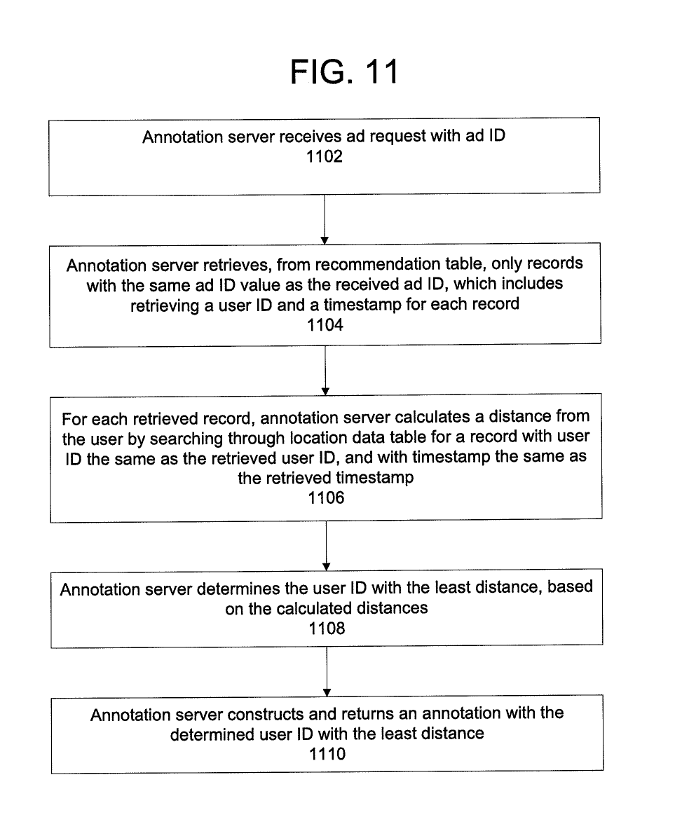

In step 524, annotation server 154 constructs annotation and returns annotation to iframe 134. The steps that annotation server 154 performs to construct the annotation according to an embodiment are illustrated in FIG. 11.

In step 526, iframe 134 receives the annotation.

In step 528, client 101 displays annotation with ad. Client 101 may display the annotation on top of the ad, or client 101 may display the annotation by making the annotation a part of the ad.

### Providing an Ad and Annotation in Reponse to an Ad Request Using Social Data Table

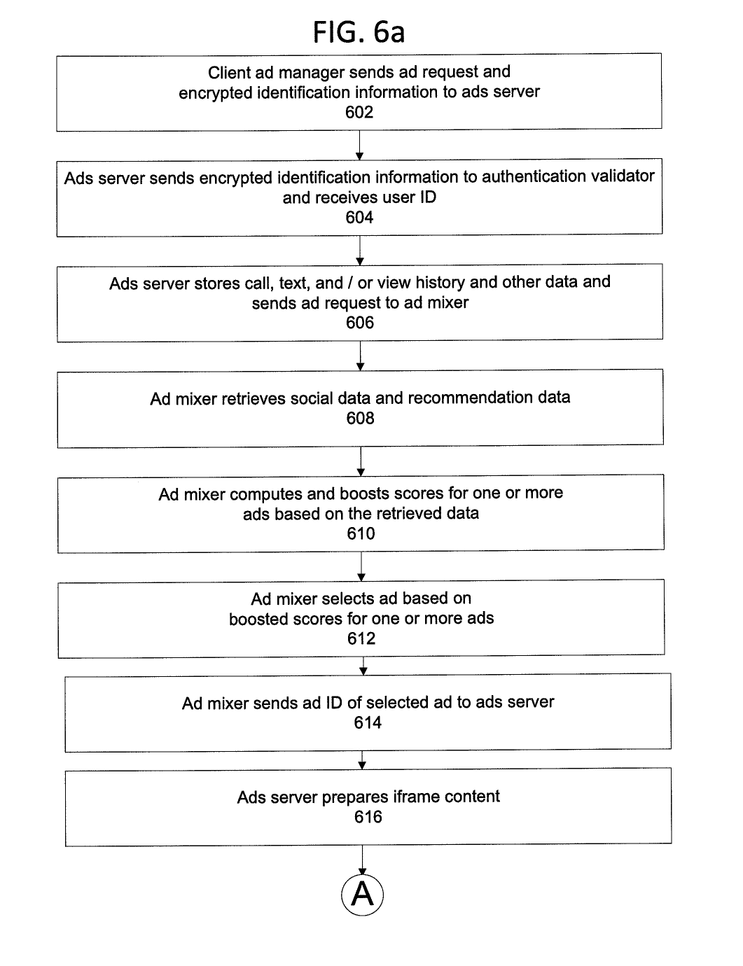

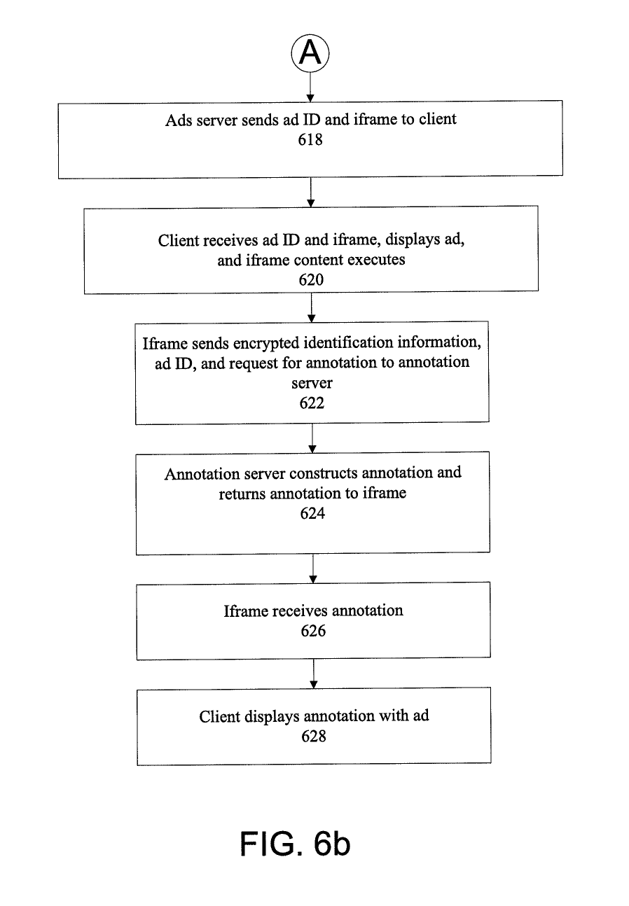

FIG. 6a and FIG. 6b together form a flow diagram illustrating providing an annotated ad using the contact data table, according to an embodiment.

In step 602, client ad manager 132 sends ad request and encrypted identification information to ads server 118. In an embodiment, the encrypted identification information is a limited ID cookie. In some embodiments, the encrypted identification information is a non-limited identification cookie or some other identifier. Client ad manager 132 manages sending ad requests to ads server 118 and receiving ad requests from ads server 118. The limited ID cookie contains an encrypted user ID that identifies the user that will be viewing the ad received from ads server 118.

In some embodiments, client ad manager 132 may also encrypt and send call, text, and view history of the user to either the ads server 118 or a front end module (not depicted in FIG. 1). The front end module or ads server 118 may decrypt the call history information and write the information into a log file. A cron job can read the call history logs and compute weights for the social data table of FIG. 4.

In step 604, ads server 118 sends encrypted identification information to authentication validator 142 and receives a user ID. In some embodiments, ads server 118 sends the limited ID cookie or the non-limited identification cookie to the authentication validator 142. In some embodiments, authentication validator 142 is the only module with the capability to decrypt the encrypted identification information and extract the user ID. This adds a level of protection to the security of the encrypted identification information.

In step 606, ads server 118 stores the call, text, and/or view history information and sends ad request to ad mixer. The history information may be used to calculate weights to store in social data table 152. In the section describing FIG. 3, history information is stored for a contact when a recommendation is made by the contact. In contrast, in step 606, history information is stored for a user for whom an ad is requested.

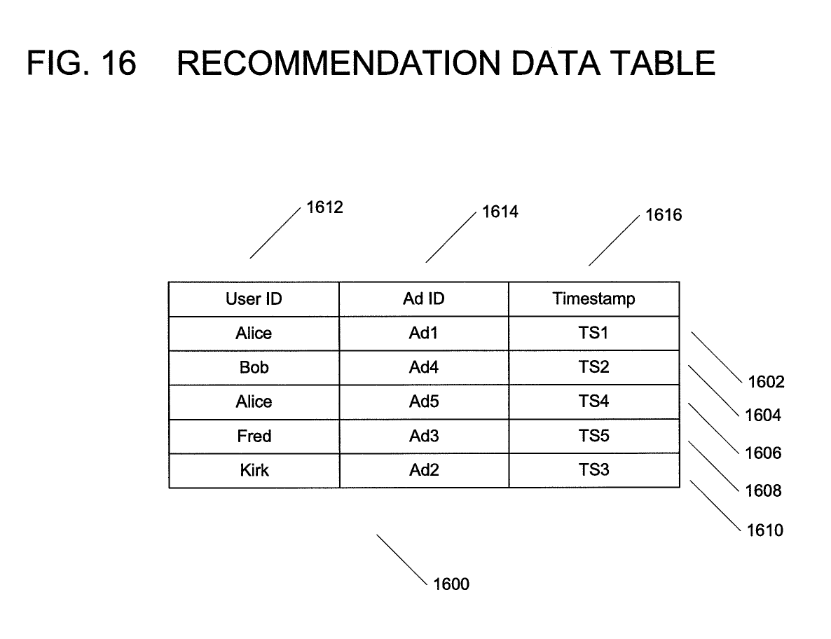

In step 608, ad mixer 150 retrieves social data and recommendation data. Ad mixer 150 retrieves the data from the social data table 152 and recommendation table. Some of the data retrieval may be performed by ad mixer 150 as part of step 610, during the computing and score boosting process. The data may also be retrieved and cached for computation at ad mixer 150, in order to increase performance for step 610. In an embodiment, ad mixer 150 retrieves only recommendation records associated with contacts of the user. FIG. 16 provides additional detail regarding the recommendation records that are retrieved for boosting scores of ads.

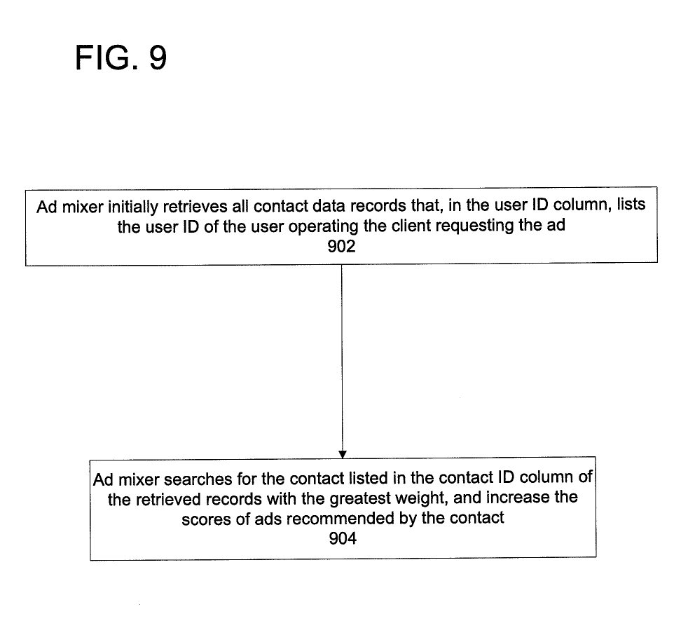

In step 610, ad mixer 150 computes and boosts scores for one or more ads based on the retrieved data. Ad mixer 150 uses the retrieved social data and recommendation data to boost scores of some ads. In an embodiment, ad mixer 150 may also use an index of sorted weight data in order to efficiently determine the contacts with the greatest weights. Such an index may contain pointers to social data records that contain information regarding contacts with the greatest weights. FIG. 9 provides additional detail regarding the combination of steps 608 and 610.

In step 612, ad mixer 150 selects an ad based on boosted scores for one or more ads. Ad mixer 150 selects the ad with highest score, after boosting scores for the ads.

In step 614, ad mixer 150 sends an ad ID of the selected ad to ads server 118.

In step 616, ads server 118 prepares iframe content. Ads server 118 may iframe content that will be sent to client 101 for installation and execution.

In step 618, ads server 118 sends ad ID and the iframe content to client 101.

In step 620, client 101 receives ad ID and the iframe content, displays ad, and the iframe content executes within an inline frame on the client. The iframe code initializes after installation, and executes in order to send an annotation request to annotation server 154 and receive an annotation from the annotation server 154.

In step 622, iframe 134 sends encrypted identification information, ad ID, and request for annotation to annotation server 154. The encrypted identification information may be a limited ID cookie, a non-limited identification cookie, or some other encrypted identifier. The iframe communicates with annotation server 154 to request an annotation and receive the annotation.

In step 624, annotation server 154 constructs annotation and returns annotation to iframe 134. The steps that annotation server 154 performs to construct the annotation according to an embodiment are illustrated in FIG. 11.

In step 626, iframe 134 receives the annotation.

In step 628, client 101 displays annotation with ad. Client 101 may display the annotation on top of the ad, or client 101 may display the annotation by making the annotation a part of the ad.

### Providing an Ad and Annotation in Response to an Ad Request Using Contact Data Table and Location Data Table

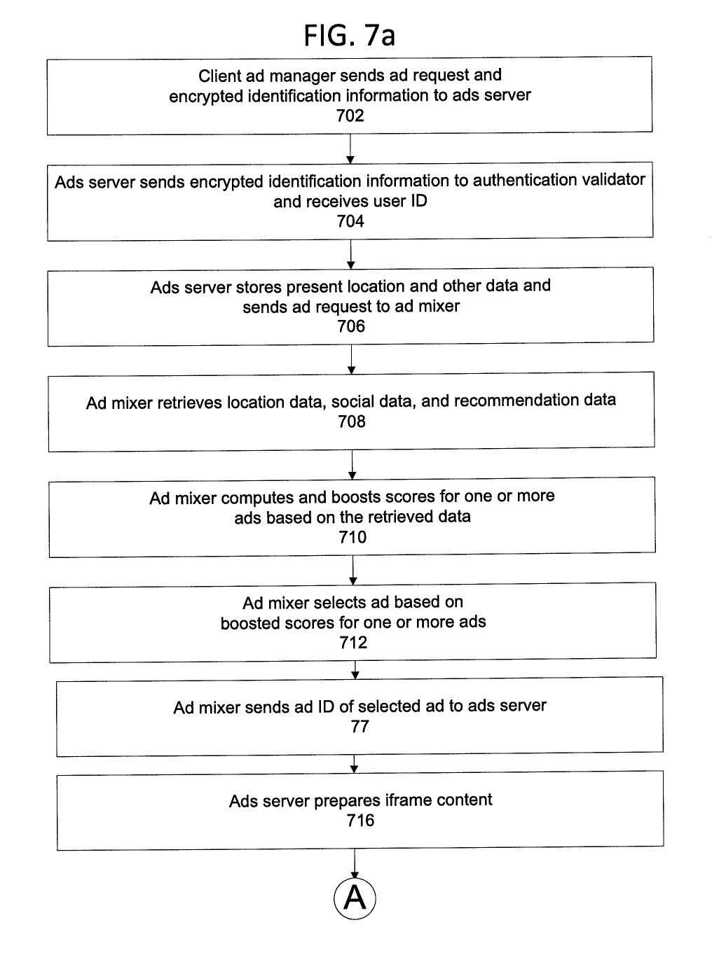

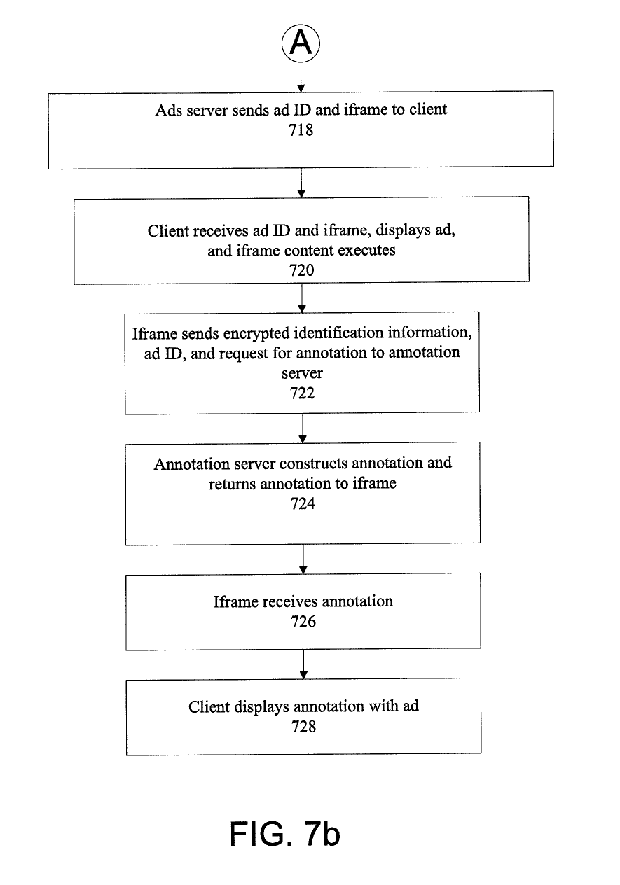

FIG. 7a and FIG. 7b together foam a flow diagram illustrating providing an annotated ad using the contact data table, according to an embodiment.

In step 702, client ad manager 132 sends ad request and encrypted identification information to ads server 118. In an embodiment, the encrypted identification information may be a limited ID cookie or a permanent identification identifier. Client ad manager 132 manages sending ad requests to ads server 118 and receiving ad requests from ads server 118. The encrypted identification information contains an encrypted user ID that identifies the user that will be viewing the ad received from ads server 118. Client ad manager 132 may also send the current location of the user to ads server 118. Client 101 may obtain the current location of the client device using a global positioning system or cell phone tower triangulation, and client ad manager 132 sends the current location to the ads server. In some embodiments, client 101 may also obtain the current location of the client device by examining the IP address of the client device.

In some embodiments, client ad manager 132 may also encrypt and send call, text, and view history of the user to either the ads server 118 or a front end module (not depicted in FIG. 1). The front end module or ads server 118 may decrypt the call history information and write the information into a log file. A cron job can read the call history logs and compute weights for the social data table of FIG. 4.

In step 704, ads server 118 sends the encrypted identification information to authentication validator 142 and receives user ID. In some embodiments, authentication validator 142 is the only module with the capability to decrypt the encrypted identification information and extract the user ID. This adds a level of protection to the security of the encrypted identification information.

In step 706, ads server 118 stores the present location of the user and other data and sends ad request to ad mixer 150. In some embodiments, the stored location information may be used the next time the distance between the location of the user and location of a recommendation made by the user's contact is determined. The stored location information may be used as a most recently known location of the user. In some embodiments, the location stored may contain protocol buffer with fields for street, city/zip code, country, latitude, and longitude, as described in the present specification.

Ads server 118 may also store call, text, and/or view history information. The history information may be used to calculate weights to store in social data table 152. In FIG. 2, history information is stored for a contact when a recommendation is made by the contact. In contrast, in step 1106, history information is stored for a user for whom an ad is requested.

In step 708, ad mixer 150 retrieves location data, social data, and recommendation data. Ad mixer 150 retrieves the data from the location table, social data table 152, and recommendation table, respectively. Some of the data retrieval may be performed by ad mixer 150 as part of step 1110, during the computing and score boosting process. The data may also be retrieved and cached for computation at ad mixer 150, in order to increase performance for step 1110. In an embodiment, ad mixer 150 retrieves only recommendation records associated with contacts of the user. FIG. 8 provides additional detail regarding the recommendation records that are retrieved for boosting scores of ads.

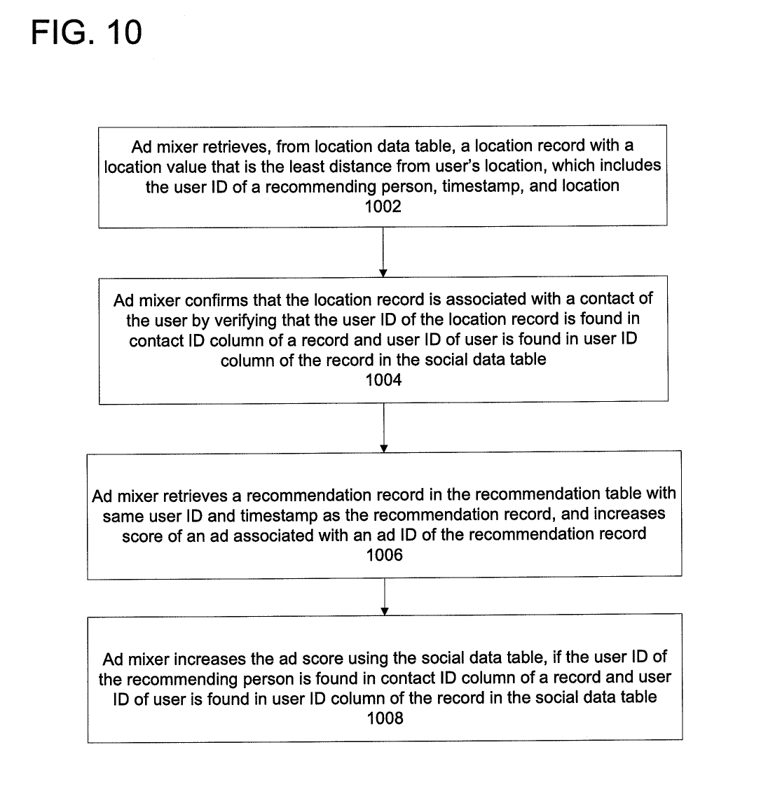

In step 710, ad mixer 150 computes and boosts scores for one or more ads based on the retrieved data. Ad mixer 150 uses the retrieved location data, social data, and recommendation data to boost scores of some ads. Ad mixer 150 may also use an index of sorted location data in order to efficiently determine the nearest locations associated with recommendations by contacts. FIG. 10 provides additional detail regarding the combination of steps 708 and 710.

In step 712, ad mixer 150 selects an ad based on boosted scores for one or more ads. Ad mixer 150 selects the ad with highest score, after boosting scores for the ads.

In step 714, ad mixer 150 sends an ad ID of the selected ad to ads server 118.

In step 716, ads server 118 prepares iframe content. Ads server 118 may prepare iframe content that will be sent to the client and displayed within an inline frame at the client.

In step 718, ads server 118 sends ad ID and iframe content to client 101.

In step 720, client 101 receives ad ID and iframe content, displays ad, and iframe content executes within the inline frame. The iframe content executes in order to send an annotation request to annotation server 154 and receive an annotation from the annotation server 154.

In step 722, iframe 134 sends encrypted identification information, ad ID, and request for annotation to annotation server 154. The encrypted identification information may be a limited ID cookie, a non-limited identification cookie, or some other encrypted identifier. The iframe communicates with annotation server 154 to request an annotation and receive the annotation.

In step 724, annotation server 154 constructs annotation and returns annotation to iframe 134. The steps that annotation server 154 performs to construct the annotation according to an embodiment are illustrated in FIG. 11.

In step 726, iframe 134 receives the annotation.

In step 728, client 101 displays annotation with ad. Client 101 may display the annotation on top of the ad, or client 101 may display the annotation by making the annotation a part of the ad.

### Boosting a Score of an Ad Using Location Data

FIG. 8 is a flow diagram illustrating steps for boosting a score of an ad using location data, according to an embodiment.

In step 802, ad mixer 150 retrieves, from location data table 151, a location record with a location value that is the least distance from user's location, which includes the user ID of a recommending person, timestamp, and location. This location record, in conjunction with a matching recommendation record, has data that represents the least distance recommendation. A location record and a recommendation record are matching if the user ID and timestamp values are the same in both records. In some embodiments, ad mixer 150 may search through the location data table 151 for the location record with a location value that is the least distance from the location of the user operating the client device. The distance between the location of the client device and the location of the user operating the client device may be considered to be the same for the purposes of this patent specification. In an embodiment, location records with a location that exceeds a distance threshold are not used for boosting ad scores. In one embodiment, the location of the content of the recommended ad can be used as the threshold. For example, if the ad being recommended to a San Jose user is about China and the ad has been recommended by a contact in China, then that location record is within the threshold. In another embodiment, the distance threshold can be a certain number of maximum miles. For example, the distance threshold can be 50 miles.

In some embodiments, ad mixer 150 may search for a location record that represents a least distance recommendation made at a location that is closest to the user. The least distance is obtained by computing a distance from the location value of each location record to the location of the user. The location record with the minimum location value that is computed through this process represents the location of the least distance recommendation. The minimum location value should have a computed distance that is not greater than any other distance from any other location value of the location table to the location of the user. The location record that ad mixer finds should, in conjunction with a matching recommendation record, represent the geographically nearest recommendation that was made.

In some embodiments, ad mixer 150 computes the least distance by using the current location of the user. In some embodiments, ad mixer 150 computes the least distance by using the most recently known location of the user. The most recently known location of the user is stored by ads server when ad server receives an ad request from the client. The most recently known location of the user is a good estimate of where the user is located currently, if the actual current location of the user is not available. For example, if the user is in an area where a GPS signal is unavailable, then the current location of the user might be unknown. Under this circumstance the most recently known location of the user provides a good estimate of the current location of the user for use in computing the least distance.

In some embodiments, ad mixer 150 may use an index to directly obtain, from the location data table 151, the location record associated with a least distance recommendation. By using an index, ad mixer 150 efficiently performs the step of 402 in a constant, short amount of time. The index stores a sorted list of location records. The index may store a sorted list of the locations found in the location data table 151. The locations may be sorted by distance to the user within the index.

In some embodiments, the cron job may offline (i.e. asynchronously) update the index based on user location information obtained from ad request logs. In such embodiments, as the user changes location, the cron job may offline update the index based on the new location of the user. When an ad request is received, ad mixer 150 may use the index to directly obtain, from the location data table 151, the location record with a location value that is the least distance from the user. In some embodiments, the index includes a list of pointers that point to records of the location table.

In step 804, ad mixer 150 retrieves a recommendation record from the recommendation data table 153 with same user ID and timestamp as the location data record, and increases the score of an ad associated with an ad ID of the recommendation record. In some embodiments, the boost value is inversely proportional to the least distance. For example, ad mixer 150 may increase the ad score by assigning a value of (1/d) to a boost value, where d is the distance between the user and the recommendation location. The boost value may then be added to the boost score.

In some embodiments, multiple closest locations associated with each ad are used to determine the boost value for increasing the score of the ad. In some embodiments, the formula to calculate the boost value using more than one location is Σ (1/i), for i=1 to n, where i is the distance to each location, and n is the number of closest locations for increasing the score of the ad. For example, the boost value may be calculated as (½)+(⅓)+(¼)=1.08 for an ad where the closest recommendation locations are 2 miles, 3 miles, and 4 miles. In order to calculate the boost value using more than one recommendation location, in an embodiment, for each ad ID, ads scorer may retrieve only recommendations with a particular ad ID from recommendation data table 153, and determine the set of locations with minimum distances and boost ad scores using the steps of FIG. 8.

### Boosting a Score of an Ad Using Social Data

FIG. 9 is a flow diagram illustrating boosting ad scores using social data, according to an embodiment. In some embodiments, ad mixer 150 may increase the score of an ad based on social data indicating that a contact and the user have greater social affinity.

In step 902, ad mixer initially retrieves all contact data records that, in the user ID column, list the user ID of the user operating the client requesting the ad. By this step, ad mixer filters the contacts that may be used for increasing the score of ads to only those contacts associated with the user requesting the ad.

In step 904, in some embodiments, ad mixer searches for the contact listed in the contact ID column of the retrieved records with the greatest weight. All of the ads that have been recommended by the contact with the greatest weight have their ad scores increased. In other words, in such embodiments, the contact with the greatest weight has the ad scores of all of the ads that the contact has recommended increased by the weight value. For example, since Alice is the contact of Bob with a weight of 0.8 in social data record 1504 that is the highest weight, both Ad1 and Ad5 in recommendation data records 1602 and 1606, respectively, have their ad scores increased by 0.8.

In some embodiments, for each contact listed in the contact ID column of the retrieved records, ad mixer increases the ad scores of all ads of the contact by an associated weight. The associated weight is listed in the same record as the contact. In other words, all of the ads associated with each contact of the user receive an ad score increase. The ads with the increased scores are now more likely to be selected to be sent to client 101 for display.

The weight value reflects the frequency of views, calls, and/or text messages between the user ID listed in the user ID column and the user ID list in the content ID column. Additional details regarding the entry of the weight data into the social data table is discussed with respect to FIG. 3.

### Boosting a Score of an Ad Using Location Data Table and Social Data Table

FIG. 10 is a flow diagram illustrating steps for boosting a score of an ad, according to an embodiment.

In step 1002, ad mixer 150 retrieves, from location data table 151, a location record with a location value that is the least distance from user's location, which includes the user ID of a recommending person, timestamp, and location. This location record, in conjunction with a matching recommendation record, has data that represents the least distance recommendation. A location record and a recommendation record are matching if the user ID and timestamp values are the same in both records. In some embodiments, ad mixer 150 may search through the location data table 151 for the location record with a location value that is the least distance from the location of the user operating the client device. The distance between the location of the client device and the location of the user operating the client device may be considered to be the same for the purposes of this patent specification. In an embodiment, location records with a location that exceeds a distance threshold are not used for boosting ad scores, as described in the present specification.

Ad mixer 150 may search for a location record that represents a least distance recommendation made at a location that is closest to the user. The least distance is obtained by computing a distance from the location value of each location record to the location of the user. The location record with the minimum location value that is computed through this process represents the location of the least distance recommendation. The minimum location value should have a computed distance that is not greater than any other distance from any other location value of the location table to the location of the user. The location record that ad mixer finds should, in conjunction with a matching recommendation record, represent the geographically nearest recommendation that was made.

In some embodiments, ad mixer 150 computes the least distance by using the current location of the user. In some embodiments, ad mixer 150 computes the least distance by using the most recently known location of the user. The most recently known location of the user is stored by ads server when ad server receives an ad request from the client. The most recently known location of the user is a good estimate of where the user is located currently, if the actual current location of the user is not available. For example, if the user is in an area where a GPS signal is unavailable, then the current location of the user might be unknown. Under this circumstance the most recently known location of the user provides a good estimate of the current location of the user for use in computing the least distance.

In step 1004, ad mixer confirms that the location record is associated with a contact of the user by verifying that the user ID of the location record is found in the contact ID column of a record and user ID of user is found in the user ID column of the record in the social data table. Since some of the records in location data table and recommendation data table may be associated with recommendations not made by contacts of the user, ad mixer effectively filters out recommendations made by non-contacts. In an embodiment, ad mixer only boosts least distance recommendations made by contacts of the user.

In some embodiments, ad mixer 150 may use an index to directly obtain, from the location data table 151, the location record associated with a least distance recommendation from a contact. By using an index, ad mixer 150 efficiently performs the steps of 1702 and 1704 in a constant, short amount of time. The index stores a sorted list of location records where each of the location records are associated with a contact of the user. The index may store a sorted list of the locations found in the location data table 151. The locations may be sorted by distance to the user within the index. A cron job may verify each new location record is associated with a contact before adding the location record to the index. The verification can be performed by verifying that the user ID of the new location record is in the contact ID column of a social data record that has the user ID of the user in the user ID column.

In some embodiments, the cron job may offline (i.e. asynchronously) update the index based on user location information obtained from ad request logs. In such embodiments, as the user changes location, the cron job may offline update the index based on the new location of the user. When an ad request is received, ad mixer 150 may use the index to directly obtain, from the location data table 151, the location record with a location value that is the least distance from the user. In some embodiments, the index includes a list of pointers that point to records of the location table.

In step 1006, ad mixer 150 retrieves a recommendation record in the recommendation data table 153 with same user ID and timestamp as the recommendation record, and increases the score of an ad associated with an ad ID of the recommendation record. In some embodiments, the boost value is inversely proportional to the least distance. For example, ad mixer 150 may increase the ad score by assigning a value of (1/d) to a boost value, where d is the distance between the user and the recommendation location. The boost value may then be added to the boost score.

In some embodiments, multiple closest locations associated with each ad are used to determine the boost value for increasing the score of the ad. In some embodiments, the formula to calculate the boost value using more than one location is (1/i), for i=1 to n, where i is the distance to each location, and n is the number of closest locations for increasing the score of the ad. For example, the boost value may be calculated as (½)+(⅓)+(¼)=1.08 for an ad where the closest recommendation locations are 2 miles, 3 miles, and 4 miles. In order to calculate the boost value using more than one recommendation location, in an embodiment, for each ad ID, ads scorer may retrieve only recommendations with a particular ad ID from recommendation data table 153, and determine the set of locations with minimum distances and boost ad scores using the steps of FIG. 3a.

In an embodiment, ad mixer 150 may skip step 1004 by retrieving only those recommendation records associated with contacts of the user. Ad mixer 150 may filter the recommendation records retrieved from the recommendation data table 153 by cross-checking with social data table 152 to ensure that the user ID of each retrieved recommendation record is also found as a contact ID for the user in social data table 152. For example, if Bob is the user operating the client, ad mixer 150 does not retrieve a recommendation record associated with a recommendation made by Kirk, since Kirk is not a contact of Bob. Ads server 150 thus avoids boosting any ads for Bob on the basis of a recommendation made by Kirk.

In step 1008, in some embodiments, ad mixer 150 increases the ad score using the social data table 152, if the user ID of the contact associated with the least distance recommendation is found in contact ID column of a record and user ID of user is found in user ID column of the record in the social data table 152. That is, ad mixer 150 may increase the ad score by using a weight listed in a social data record. If the person who made the recommendation is a contact of the user, the ad score may increase.

In some embodiments, ad mixer 150 may increase the score of all ads of all contacts listed in the social data table. The ad mixer searches for all of the recommendations made by each of the contacts, and increases the ad score of the ads listed in the recommendations.

In some embodiments, ad mixer 150 may increase the score of contacts listed in the social data table that have the highest weights. Ad mixer may search through the table for the contacts with the highest weights. Ad mixer may increase the ad scores of ads associated with one or more of the contacts with the highest weights.

### Construction of Annotation by Using Location Data Table

FIG. 11 is a flow chart illustrating construction of annotation by using location data table, according to an embodiment.

In step 1102, annotation server 154 receives an annotation request with an ad ID. Since the ad to be displayed to the user has been selected by ad mixer 150, the annotation server's task in constructing the annotation is to construct an annotation that is appropriate for the selected ad.

In step 1104, annotation server 154 retrieves, from recommendation data table 153, only records with the same ad ID value as the received ad ID, which includes retrieving a user ID and a timestamp for each record. Annotation server uses the user ID to communicate, in the annotation, which contact recommended the ad associated with the ad ID. The timestamp indicates when the contact made the recommendation, and is used in conjunction with the user ID to find a location record in location data table 151 that matches the recommendation record. In an embodiment, location records with a location that exceeds a distance threshold are not used for constructing annotations. In one embodiment, the location of the content of the recommended ad can be used as the threshold. For example, if the ad being recommended to a San Jose user is about China and the ad has been recommended by a contact in China, then that location record is within the threshold. In another embodiment, the distance threshold can be a certain number of maximum miles. For example, the distance threshold can be 50 miles, for example.

In step 1106, for each retrieved record, annotation server 154 calculates a distance from the user by searching through location data table 151 for a record with user ID the same as the retrieved user ID, and with timestamp the same as the retrieved timestamp. That is, for each retrieved recommendation record, annotation server 154 searches for a matching location record with the same user ID and timestamp as the retrieved recommendation record. After finding the matching location record, annotation server 154 determines a distance from the user for each recommendation record that was retrieved, using the location value of each matching location record.

In step 1108, annotation server 154 determines the user ID with the least distance, based on the calculated distances. With the distance from the user calculated for each retrieved recommendation record, annotation server 154 may determine the least distance recommendation that is made by a contact. The user ID of such a contact is the user ID with the least distance.

In step 1110, annotation server 154 constructs and returns an annotation using the determined user ID with the least distance. In an embodiment, the annotation constructed may be of the form user name+“recommended this application”. For example, if Bob is in Palo Alto and Alice makes the recommendation in San Jose and the recommendations of Bob's other contacts are all made at some location farther than San Jose, then the annotation may be “Alice recommended this application”.

### Construction of Annotation Using Social Data Table

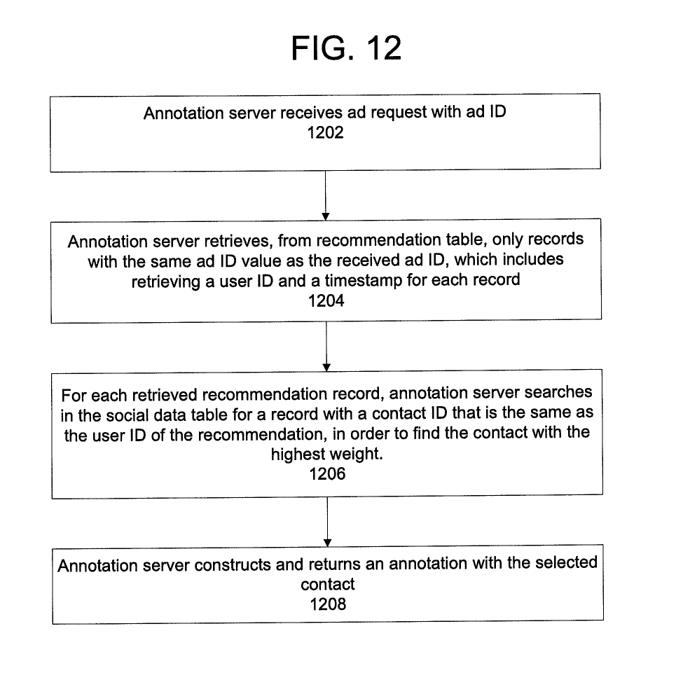

FIG. 12 is a flow chart illustrating construction of annotation using the social data table, according to an embodiment.

In step 1202, annotation server 154 receives an annotation request with an ad ID. Since the ad to be displayed to the user has been selected by ad mixer 150, the annotation server's task in constructing the annotation is to construct an annotation that is appropriate for the selected ad.

In step 1204, annotation server 154 retrieves, from recommendation data table 153, only records with the same ad ID value as the received ad ID, which includes retrieving a user ID and a timestamp for each record. Annotation server uses the user ID to communicate, in the annotation, which contact recommended the ad associated with the ad ID. The timestamp indicates when the contact made the recommendation.

In step 1206, for each retrieved recommendation record, annotation server searches in the social data table for a record with a contact ID that is the same as the user ID of the recommendation, in order to find the contact with the highest weight. The weight of the contact ID is compared against the weight of other contact IDs. The contact with the highest weight value is used in constructing the annotation. For example, if Bob is the user that requested an ad, then record 704 is retrieved. Record 704 shows that Alice is a contact of Bob with a weight of 0.8. Record 802 in recommendation table 800 shows that Alice has recommended Ad1. By combining record 704 and record 802, annotation server 154 computes that Alice has the highest weight, and therefore Alice's social data and recommendation data is used to construct the annotation. In some embodiments, annotation server 154 selects multiple contacts with the highest weights. In some embodiments, in the event that two contacts have the same weight, the contact(s) that are selected for use in annotation may be randomly selected.

In step 1208, annotation server constructs and returns an annotation with the selected contact. In an embodiment, the annotation constructed may be of the form user name+“recommended this application”. For example, if Alice is the contact that is selected for the annotation, then the annotation may be “Alice recommended this application”.

### Construction of Annotation Using Both Location Data and Social Data

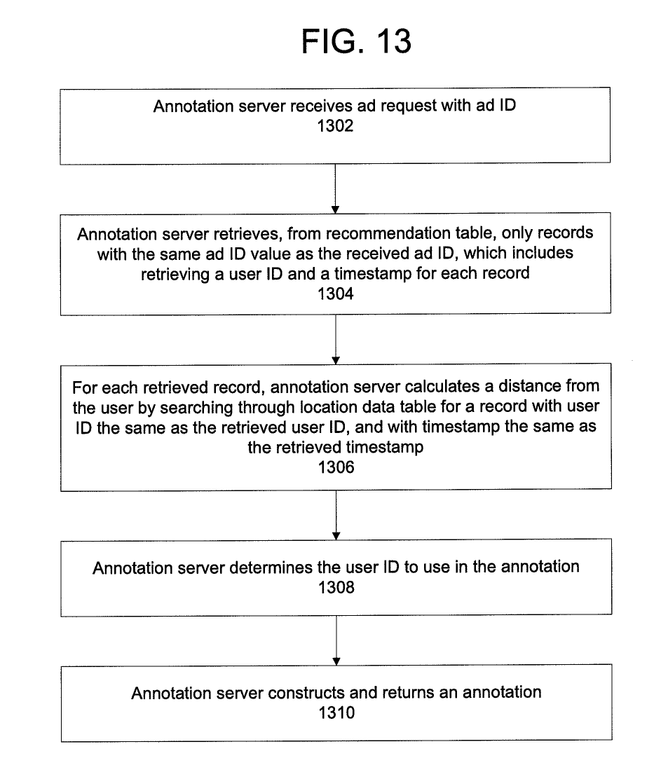

FIG. 13 is a flow chart illustrating construction of annotation using the combination of the location data table and the social data table, according to an embodiment.

In step 1302, annotation server 154 receives an annotation request with an ad ID. Since the ad to be displayed to the user has been selected by ad mixer 150, the annotation server's task in constructing the annotation is to construct an annotation that is appropriate for the selected ad.

In step 1304, annotation server 154 retrieves, from recommendation data table 153, only records with the same ad ID value as the received ad ID, which includes retrieving a user ID and a timestamp for each record. Annotation server uses the user ID to communicate, in the annotation, which contact recommended the ad associated with the ad ID. The timestamp indicates when the contact made the recommendation, and is used in conjunction with the user ID to find a location record in location data table 151 that matches the recommendation record. In an embodiment, location records with a location that exceeds a distance threshold are not used for constructing annotations, as described in the present specification.

In step 1306, for each retrieved record, annotation server 154 calculates a distance from the user by searching through location data table 151 for a record with user ID the same as the retrieved user ID, and with timestamp the same as the retrieved timestamp. That is, for each retrieved recommendation record, annotation server 154 searches for a matching location record with the same user ID and timestamp as the retrieved recommendation record. After finding the matching location record, annotation server 154 determines a distance from the user for each recommendation record that was retrieved, using the location value of each matching location record.

In step 1308, annotation server 154 determines the user ID to use in the annotation. For example, annotation server 154 may use the user ID with the least distance, based on the calculated distances. With the distance from the user calculated for each retrieved recommendation record, annotation server 154 may determine the least distance recommendation that is made by a contact. The user ID of such a contact is the user ID with the least distance.

If more than one recommendation has the same recommendation distance from the user, then annotation server 154 may use social data may to decide which recommendation to use. Annotation server 154 may examine the weights of social data records to determine which contact ID has the greatest weight for a given user ID in the user ID column. The social data record that has the greatest weight is used to decide the user ID of the contact that will be used for constructing the annotation.

In some embodiments, annotation server 154 first retrieves the social data records with the highest weight. If two or more social data records have the same highest weight, then the least distance recommendation is used to choose the social data record that is selected for annotation. That is, if two contacts have the same highest weight, then the contact that is also associated with the least distance recommendation is used for annotation.

In other embodiments, annotation server 154 may use more than one contact to construct the annotation. In such embodiments, annotation server 154 selects multiple contacts starting from the contact with the least distance or the contact with the greatest weight, and moving onto the next least distance contact or the next greatest weight contact.

In step 1310, annotation server 154 constructs and returns an annotation. For example, annotation server 154 may use the determined user ID with the least distance. In an embodiment, the annotation constructed may be of the form user name+“recommended this application”. For example, if Bob is in Palo Alto and both Alice and Joseph make the recommendation at two geographical locations that are near to each other in San Jose and the recommendations of Bob's other contacts are all made at some location farther than San Jose, then the annotation may be “Alice recommended this application”, if Alice has a higher weight value than Joseph with respect to Bob.

### Location Data Table

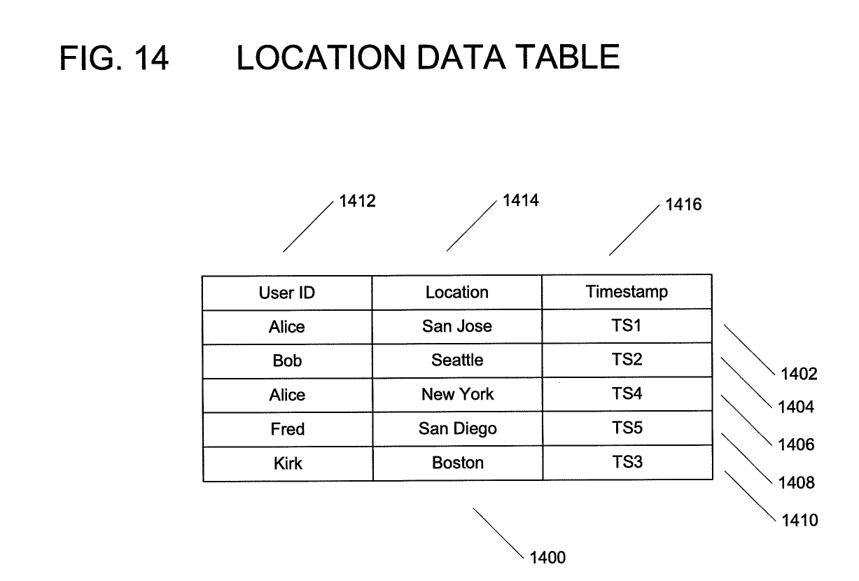

FIG. 14 illustrates a location data table, according to an embodiment. The illustrated example location data table 1400 of FIG. 14 contains records 1402, 1404, 1406, 1408, and 1410 that indicate locations of client devices where users have recommended ads and the timestamp for each recommendation. Location data table 1400 is an example of location data table 151. The location data table 1400 may include records associated with any recommendation made by any person. The location data table 1400 may be populated by ads server 118 whenever any person makes a recommendation for an ad. A User ID column 1412 in the location data table 1400 lists a user ID that indicates a person that has recommended an ad. For simplicity of illustration, in FIG. 14, the name of the user is illustrated instead of the user ID. A location column 1414 in the location data table 1400 lists, for each record, a location where the person has recommended the ad.

Annotation server 154 retrieves the records from location data table 1400 to construct annotations, each annotation indicating that a contact has recommended an ad. By searching for the same user ID and the same timestamp in both the location data table and the recommendation data table 153, annotation server 154 may construct an annotation using any of the available contact, timestamp, location, and ad ID information.

For example, annotation server 154 may retrieve records 1402 from FIG. 14 which indicates that Alice has recommended an ad at timestamp TS1 from San Jose. The user ID of Alice and the timestamp of TS1 is also found in recommendation data table record 802. Thus, annotation server 154 may construct an annotation “Alice recommended Application Ad1”. Further, the ad mixer 150 may also use the San Jose location from Alice's recommendation to boost a score of Ad1, increasing the likelihood that Ad1 will be selected by ad mixer 150 for display to any contact of Alice. In the illustrated examples, if Bob was in Palo Alto when the ad request was made to ads server 118, and if Alice's recommendation made in San Jose is the least distance recommendation, then the likelihood of Bob viewing Alice's recommendation made from San Jose increases after boosting.

### Social Data Table

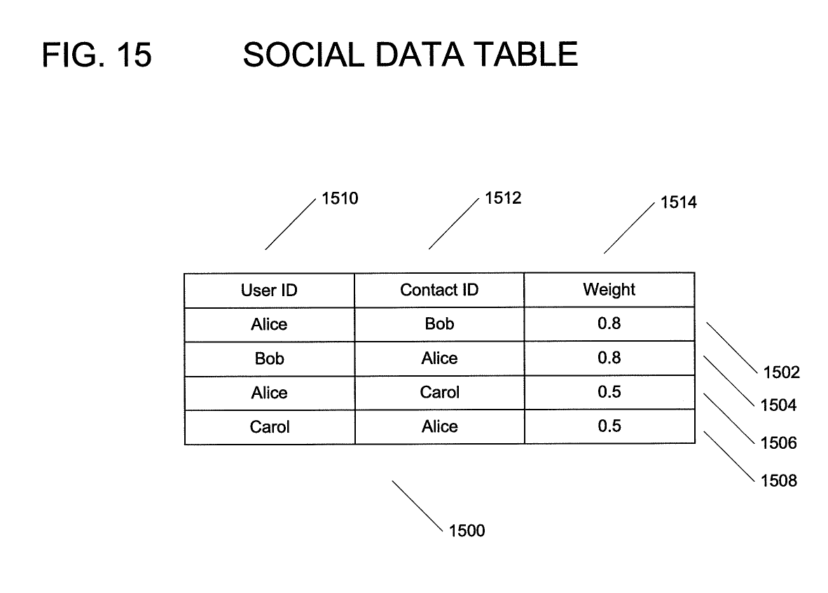

FIG. 15 illustrates a social data table, according to an embodiment. The illustrated example social data table 1500 of FIG. 15 contains records 1502, 1504, 1506, and 1508 that indicate contacts of users. Social data table 1500 is an example of social data table 152. A User ID column 1510 in the social data table 1500 lists a user ID that indicates the person with a contact (i.e. friend). For simplicity of illustration, in FIG. 4, the name of the users and/or contacts are illustrated instead of the user IDs. A Contact ID column 1512 in the social data table 1500 lists a user ID of a contact. For each record, in social data table 1500, the user ID of the person listed in the contact ID column is the contact (i.e. friend) of the person listed in the user ID column. A weight column 1514 indicates, for each record, the weight that has been assigned to the relationship between the contact in the contact ID column and the user in the user column.

Annotation server 154 retrieves one or more of the records from social data table 1500 to boost the scores of ads in ad scoring. For example, if Alice's client device submitted an ad request, annotation server 154 may boost the score of an ad that has been recommended by Bob by 0.8, based on record 1502. After boosting the score, ad mixer 150 may be more likely to select the ad with the boosted score to send back to Alice's client device for viewing.

Social data table 1500 may be populated by the front end module or ads server 118 decrypting call, text message, and view history information received from the client ad manager 132, and writing the decrypted information into a log file. The call information may be the volume and/or frequency of occurrences where the user and/or the contact calls the other on the phone. The text message information may be built volume and/or frequency of occurrences where the user and/or the contact send text messages to the other. The view history information may be the frequency and/or the volume of occurrences where the user views the information of the contact.

A cron job and/or ads server and/or annotation server can use the call, view, and/or text history data and compute weights for entering records into the social data table. In some embodiments, the call, view, and/or text history of the user and contact may be used to determine or update the weight value. In an embodiment, if the user calls the contact often, then the weight value of the contact may be set at a higher value according to some formula. If the user does not call the contact often, then the weight value of the contact may be set at a lower value. For example, if the user calls the contact every day, then the weight value may be set at 0.8. If the user calls the contact only once a month, then the weight value may be set at 0.3. In some embodiments, if the user has very lengthy conversations with the contact, then the weight is also increased accordingly. For example, if Bob calls Alice and talks to Alice every day for a few hours, then the weight between Alice and Bob can be set to 0.9, which is a higher value that reflects the greater social affinity between Bob and Alice. In some embodiments, if a first person calls a second person very often, but the second person does not reciprocate and almost never calls the first person, then the weight values may be different between the first person and the second person. For example, if only Bob calls Alice and Alice does not call Bob, then, for Bob, the weight with Alice in a contact ID column may be a high value such as 0.8. However, for Alice, the weight with Bob in a contact ID column is only 0.1. In some embodiments, the weight values may also be computed from the length of voice mails.

In an embodiment, if the user sends text messages to the contact often, then the weight value for the contact may be set at a higher value, such as 0.9. If the user does not send text messages to the contact very often, then the weight value of the contact may be set at a lower value, such as 0.2. In some embodiments, if a first person sends a text message to a second person very often, but the second person does not reciprocate by sending back text messages, then the weight values may be different between the first person and the second person. For example, if only Bob sends text messages to Alice and Alice does not send text messages to Bob, then, for Bob, the weight with Alice in the contact ID column is a high value such as 0.8. However, for Alice, the weight with Bob in a contact ID column is only 0.1.

In an embodiment, if the user views a contact profile of the contact often, then the weight value of the contact may be set at a higher value, such as 0.9. If the user almost never views the contact profile of the contact, then the weight value of the contact may be set at a lower value, such as 0.1.

In some embodiments, a system administrator may set the policy that calls are valued more than text messages, because when a user calls a contact, it means that the user cares enough about the contact to spend some time on a telephone conversation with the contact. A system administrator may set the policy that text messages are not weighted as highly as voice calls, because the user most likely just wants to avoid a conversation, and instead send a succinct message to the contact. It is likely that a short, to the point, text message to the contact indicates that the user simply wants to communicate the message without engaging in an extended conversation. For example, if Bob calls Alice very often, then the weight value for Alice as a contact may be 0.8. However, if Bob sends text messages to Alice without ever calling Alice, then the weight value for Alice as a contact may be only 0.2.

In some embodiments, a person is assigned a weight just because the person is in a user's contact list. As an example, ads server 118 may enter a weight of 0.8 for a contact if the contact is listed in the user's contact list from a phone contacts application. A contact list is a list of friends of the user, and each person listed in the contact list may have the weight of 0.8 assigned in the social data table. Thus, if Bob is in Alice's contact list, then, in the example embodiment, Bob has a weight of 0.8. Ads server 118 may enter the user ID for Alice as the user ID, Bob's user ID as the contact ID, and a weight of 0.8 for Bob. If the contact is already in the social data table 152, then ads server 118 may overwrite the record for the contact with an updated weight value. In some embodiments, a cron job reads history logs to determine the contacts of the user. Based on the contact information from the history logs, the cron job may update existing weights of contacts of the user in the social data table.

### Recommendation Data Table

FIG. 16 illustrates a recommendation data table, according to an embodiment. The illustrated example recommendation data table 1600 of FIG. 16 contains records 1602, 1604, 1606, 1608, and 1610 that indicate which users have recommended which advertisements. Recommendation data table 1600 is an example of recommendation data table 153. In an embodiment, the recommendation data table 1600 may include records associated with any recommendation made by anyone. The recommendation data table 1600 may be populated by ads server 118 whenever anyone makes a recommendation for an ad. A User ID column 1612 in the recommendation data table 1600 lists a user ID that indicates the person that has recommended the ad. For simplicity of illustration, in FIG. 16, the name of the user is illustrated instead of the user ID. An Ad ID column 1614 in the recommendation data table 1600 lists an ad ID that indicates the ad recommended by the person. Annotation server 154 retrieves the records from recommendation data table 1600 to construct annotations indicating that contacts of users have recommended ads. For example, annotation server 154 may retrieve records 1608 and 1610 from FIG. 16 which indicate that Fred has recommended Ad3 and that Kirk has recommended Ad2, respectively.

### Location Proximity Example

Examples are given below for receiving a recommendation, storing the recommendation, receiving an ad request, and returning an ads and annotation in response to the ad request, for each of the location proximity embodiment, contact affinity embodiment, and the combination of the location proximity and contact affinity embodiment.

In one example illustrative of the location proximity embodiment, Alice is in San Jose viewing a webpage, and sees an advertisement. The advertisement includes a recommendation control. Alice likes what she sees on the advertisement and clicks on the recommendation control to recommend the advertisement. Alice is operating a client device, such as client 101. A client ad manager on Alice's client device may get Alice's location from a GPS module, such as GPS 103. The client ad manager may also retrieve a cookie, such as the limited ID cookie or some other encrypted identification information stored in client 101. The client ad manager may send the encrypted identification information, ad ID of the ad that Alice clicked on, and Alice's location to an ads server, such as ads server 118. The ads server receives the sent data, and creates records for storage. The ads server may create a location data record for entering into location data table, such as record 1402 of FIG. 14. The ads server may also create a recommendation data record for entering into the recommendation table, such as record 1602 of FIG. 16. The ads server may then enter the created records into their respective tables.

Later, Bob is in San Jose and is operating his client device, which is another example of client 101. Bob downloads and installs an application that displays advertisements, and then executes the application. A client ad manager that is part of the application, upon execution, sends an ad request to an ad server, such as ad server 118. The ad request may also include Bob's location and encrypted identification information. The ads server may save Bob's location information in a storage location. The ads server may also send the encrypted identification information to an authentication validator, such as authentication validator 142. The authentication validator returns a user ID for Bob to the ads server. The ads server may send an ad request to an ad mixer, such as ad mixer 150. The ad mixer may search through a location table, such as location data table 1400, for a location data record that is closest to Bob. The ad mixer may find that the location data record that is the least distance away from Bob is the recommendation record of Alice. Thus, Alice's recommendation is the least distance recommendation. There may be other contacts of Bob that have made recommendations outside of San Jose, but, for this example, those recommendations were made at a farther distance from Bob's current location then Alice's recommendation.

The ad mixer may retrieve a recommendation record from the recommendation data table with the same user ID and timestamp as the location record, such as recommendation data record 1602 of FIG. 16. The ad mixer may increase the score of the ad associated with the ad ID of the recommendation record. The ad mixer may increase the score by 2, since Bob is approximately half a mile away, using a formula of ad score increase =(1/distance). Next, the ad mixer may select an ad based on the scores of ads. If the ad associated with the ad ID of Alice's recommendation has the highest ad score, then the ad mixer may select the ad. The ad mixer may send the ad ID of the ad to the ads server. The ads server may send the ad ID and iframe content to the client. The client may display the ad or wait to receive the annotation before displaying the ad. The iframe content may execute to request an annotation from an annotation server, such as annotation server 154. The annotation server receives a user ID from the iframe content executing on the client.

In order to construct an annotation for the client, the annotation server initially retrieves all records from recommendation data table with the same ad ID as the ID received from the client. The annotation server may calculate a distance from the current physical location of Bob, for each recommendation data record. The annotation server may match each recommendation data record to a location data record, in order to calculate the distance for each recommendation data record. After all of the distances for the recommendation data records have been computed, the annotation server may select the least distance recommendation, and constructs an annotation using the user ID of the recommendation data record associated with the least distance recommendation. The example may be “Alice recommended this application”. The annotation server may send the annotation to the client. Bob's client device receives the annotation, and displays the annotation with or on top of the ad.

### Contact Affinity Example

In one example illustrative of the contact affinity embodiment, Alice is in San Jose viewing a webpage, and sees an advertisement. The advertisement includes a recommendation control. Alice likes what she sees on the advertisement and clicks on the recommendation control to recommend the advertisement. Alice is operating a client device, such as client 101. A client ad manager may retrieve a cookie, such as the limited ID cookie or some other encrypted identification information stored in client 101. The client ad manager may send a list of Alice's contacts, the ad ID of the ad that Alice clicked on, the encrypted identification information, and Alice's encrypted call, text message, and view history to an ads server, such as ads server 118.

The ads server may receive the sent data, decrypt the data, and write the data into a log file. A cron job may read the history log and compute weights for creating records that are entered into the social data table, such as record 1504 of FIG. 15. Alice and Bob may talk on the phone every day. Because of the frequent conversations between Alice and Bob, the cron job may compute a high weight value for Alice and Bob. For example, the cron job might enter a weight value of 0.8 for the relationship between Alice and Bob. In some embodiments, the cron job might enter different weight values depending on whether Alice's user ID is in the user ID column or Bob's user ID is in the user ID column. The ads server may create a social data record for entering into social data table. Such a social data record may be record 1504 of FIG. 15. In some embodiments, the ads server may also enter a social data record such as record 1502 of FIG. 15. The ads server may also create a recommendation data record for entering into the recommendation table, such as record 1402 of FIG. 14. The ads server may then enter the created records into their respective tables.

Later, Bob is in San Jose and is operating his client device, which is another example of client 101. Bob downloads and installs an application that displays advertisements, and then executes the application. A client ad manager that is part of the application, upon execution, may send an ad request to an ad server, such as ad server 118. The ad request may also include Bob's call, view, and text message history and encrypted identification information. The ads server may save Bob's history information in a storage location. The ads server or another component, such as a cron job, may create social data records for entry into social data table. Such a social data entry may be record 1504 of FIG. 15. The ads server may also send the encrypted identification information to an authentication validator, such as authentication validator 142. The authentication validator 142 returns a user ID for Bob to the ads server. The ads server may send an ad request to an ad mixer, such as ad mixer 150. The ad mixer may search through a social data table, such as social data table 152, for a social contact that has the greatest weight for Bob. The ad mixer may find that the contact that has the greatest weight for Bob is Alice.

The ad mixer may increase the ad score for all of Alice's recommendations by the weight value. If the original score all of an ad is 0.2, a weight value of 0.6 might be added to the original score, for a total ad score value of 0.8. Such ads that have their ad scores increased might be Ad1 and Ad5 of record 1602 and record 1606 in FIG. 16. Next, the ad mixer may select an ad based on the scores of ads. If the ad associated with the ad ID of Alice's recommendation has the highest ad score, then the ad mixer selects the ad. Ad mixer sends the ad ID of the ad to the ads server. The ads server sends the ad ID and iframe content to the client. The client may display the ad or wait to receive the annotation before displaying the ad. The iframe content executes to request an annotation from an annotation server, such as annotation server 154. The annotation server receives a user ID from the iframe content executing on the client.

In order to construct an annotation for the client, the annotation server may initially retrieve all records from recommendation data table with the same ad ID as the ad ID received from the client. The annotation server may search in the social data table for the contact with the highest weight. The annotation server may construct the annotation using the contact with the highest weight. The annotation server in this example may determine that Alice has the highest weight of 0.8 for Bob, based on the record 1504 of FIG. 15. In this example, the annotation server may construct the annotation “Alice has recommended this application”. The annotation server sends the annotation to the client. Bob's client device receives the annotation, and displays the annotation with or on top of the ad.

### Location Proximity and Contact Affinity Example

In one example illustrative of the combination of location proximity and contact affinity embodiment, Alice is in San Jose viewing a webpage, and sees an advertisement. The advertisement includes a recommendation control. Alice likes what she sees on the advertisement and clicks on the recommendation control to recommend the advertisement. Alice is operating a client device, such as client 101. A client ad manager on Alice's client device may get Alice's location from a GPS module, such as GPS 103. A client ad manager may retrieve a cookie, such as the limited ID cookie or some other encrypted identification information stored in client 101. The client ad manager may send Alice's location, a list of Alice's contacts, the ad ID of the ad that Alice clicked on, the encrypted identification information, and Alice's encrypted call, text message, and view history to an ads server, such as ads server 118.

The ads server may receive the sent data, decrypt the data, and write the data into a log file. A cron job may read the history log and compute weights for creating records that are entered into the social data table, such as a record 1504 of FIG. 15. The ads server may create a location data record for entering into location data table, such as record 1402 of FIG. 14. Alice and Bob may talk on the phone every day. Because of the frequent conversations between Alice and Bob, the cron job may compute a high weight value for Alice and Bob. For example, the cron job might enter a weight value of 0.8 for the relationship between Alice and Bob. In some embodiments, the cron job might enter different weight values depending on whether Alice's user ID is in the user ID column or Bob's user ID is in the user ID column. The ads server may create a social data record for entering into social data table. Such a social data record may be record 1504 of FIG. 15. In some embodiments, the ads server may also enter a social data record such as record 1502 of FIG. 15. The ads server may also create a recommendation data record for entering into the recommendation table, such as record 1602 of FIG. 16. The ads server may then enter the created records into their respective tables.

Later, Bob is in San Jose and is operating his client device, which is another example of client 101. Bob downloads and installs an application that displays advertisements, and then executes the application. A client ad manager that is part of the application, upon execution, may send an ad request to an ad server, such as ad server 118. The ad request may also include Bob's location, Bob's call, view, and text message history and encrypted identification information. The ads server may save Bob's history information and Bob's location in a storage location. The ads server or another component, such as a cron job, may create social data records for entry into social data table. Such a social data entry may be record 1504 of FIG. 15. The ads server may also send the encrypted identification information to an authentication validator, such as authentication validator 142. The authentication validator 142 returns a user ID for Bob to the ads server. The ads server may send an ad request to an ad mixer, such as ad mixer 150.

The ad mixer may search through a location table, such as location data table 1400, for a location data record that is closest to Bob. The ad mixer may find that the location data record that is the least distance away from Bob is the recommendation record of Alice, such as record 1602. Recommendation data record 1602 shows that Ad1 was recommended at timestamp TS1, and location data table shows that Alice made a recommendation in San Jose at timestamp TS1. Thus, since Bob is in San Jose also, Alice's recommendation is the least distance recommendation. The ad mixer may then increase the ad score for Ad1 based on recommendation data record 1602. The ad mixer may increase the score by 2, if Bob is approximately half a mile away, using a formula of ad score increase=(1/distance).

The ad mixer may search through a social data table, such as social data table 152, to determine a weight for Alice. The ad mixer may find that Alice has the weight of 0.8 for Bob, as shown in record 1504 of social data table in FIG. 15. The ad mixer may also increase the ads score of Ad1 by 0.8.

The ad mixer may increase the ad score for all of Alice's recommendations by the weight value. If the original score all of an ad is 0.2, a weight value of 0.6 might be added to the original score, for a total ad score value of 0.8. Such ads that have their ad scores increased might be Ad1 and Ad5 of record 1602 in FIG. 16. Next, the ad mixer may select an ad based on the scores of ads. If the ad associated with the ad ID of Alice's recommendation has the highest ad score, then the ad mixer selects the ad. Ad mixer sends the ad ID of the ad to the ads server. The ads server sends the ad ID and iframe content to the client. The client may display the ad or wait to receive the annotation before displaying the ad. The iframe content executes to request an annotation from an annotation server, such as annotation server 154. The annotation server receives a user ID from the iframe content executing on the client.

In order to construct an annotation for the client, the annotation server may initially retrieve all records from recommendation data table with the same ad ID as the ad ID received from the client. The annotation server may search in the social data table for the contact with the highest weight. The annotation server may construct the annotation using the contact with the highest weight. The annotation server in this example may determine that Alice has the highest weight of 0.8 for Bob, based on the record 1504 of FIG. 15.

Alternatively, the annotation server may also construct annotation using the contact associated with the least distance recommendation. Thus, the annotation server may determine that Ad1 of record 1602 of FIG. 16 has a recommendation location that is closest to Bob's physical location. The annotation server may then construct the annotation with Alice as the contact.

In this example, the annotation server may construct the annotation “Alice has recommended this application”. The annotation server sends the annotation to the client. Bob's client device receives the annotation, and displays the annotation with or on top of the ad.

### Other Content

Although embodiments of the invention are described herein for serving advertisements, the techniques described herein may also apply for serving any content. The techniques described herein may be used to construct annotations and serve the annotations with any content. The annotations may be displayed with or on top of the content. Such content may be, for example, any written or video advertisement for a pizza, a movie advertisement, an entertainment program, a video, a news story, pictures, a written report, an analysis or report of some data, or any other content.

### Example Embodiments

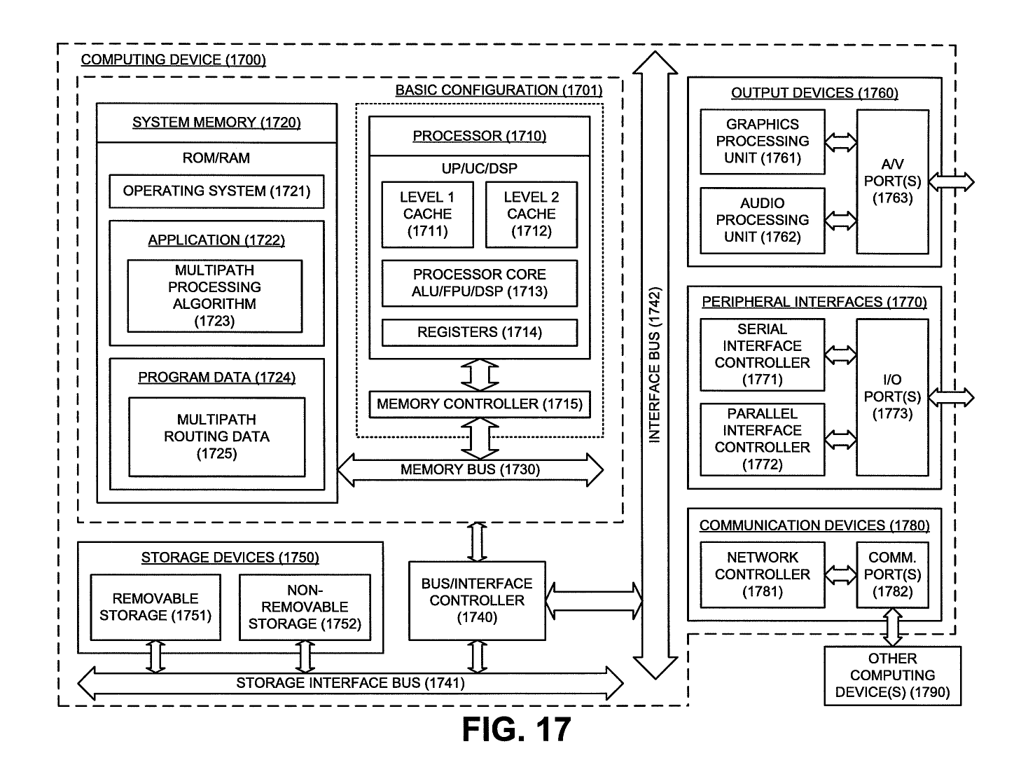

FIG. 17 is a block diagram illustrating another exemplary system 1700 upon which embodiments may be implemented. For example, ads server 118, annotation server 154, ad mixer 150, and authentication validator 142 may be implemented with system 1700. In a very basic configuration 1701, computing device 1700 typically includes one or more processors 1710 and system memory 1720. A memory bus 1730 can be used for communicating between the processor 1710 and the system memory 1720.

Depending on the desired configuration, processor 1710 can be of any type including but not limited to a microprocessor (μP), a microcontroller (μC), a digital signal processor (DSP), or any combination thereof. Processor 1710 can include one more levels of caching, such as a level one cache 1711 and a level two cache 1712, a processor core 1713, and registers 1714. The processor core 1713 can include an arithmetic logic unit (ALU), a floating point unit (FPU), a digital signal processing core (DSP Core), or any combination thereof. A memory controller 1715 can also be used with the processor 1710, or in some implementations the memory controller 1715 can be an internal part of the processor 1710.

Depending on the desired configuration, the system memory 1720 can be of any type including but not limited to volatile memory (such as RAM), non-volatile memory (such as ROM, flash memory, etc.) or any combination thereof. System memory 1720 typically includes an operating system 1721, one or more applications 1722, and program data 1724. In some embodiments, application 1722 can be arranged to operate with program data 1724 on an operating system 1721. This described basic configuration is illustrated in FIG. 3 by those components within dashed line 1701.

Computing device 1700 can have additional features or functionality, and additional interfaces to facilitate communications between the basic configuration 1701 and any required devices and interfaces. For example, a bus/interface controller 1740 can be used to facilitate communications between the basic configuration 1701 and one or more data storage devices 1750 via a storage interface bus 1741. The data storage devices 1750 can be removable storage devices 1751, non-removable storage devices 1752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 1720, removable storage 1751 and non-removable storage 1752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1700. Any such computer storage media can be part of device 1700.

Computing device 1700 can also include an interface bus 1742 for facilitating communication from various interface devices (e.g., output interfaces, peripheral interfaces, and communication interfaces) to the basic configuration 1701 via the bus/interface controller 1740. Example output devices 1760 include a graphics processing unit 1761 and an audio processing unit 1762, which can be configured to communicate to various external devices such as a display or speakers via one or more A/V ports 1763. Example peripheral interfaces 1770 include a serial interface controller 1771 or a parallel interface controller 1772, which can be configured to communicate with external devices such as input devices (e.g., keyboard, mouse, pen, voice input device, touch input device, etc.) or other peripheral devices (e.g., printer, scanner, etc.) via one or more I/O ports 1773. An example communication device 1780 includes a network controller 1781, which can be arranged to facilitate communications with one or more other computing devices 1790 over a network communication via one or more communication ports 1782. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 1700 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1700 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry our part or all of the method variations discussed above. Such variations are not to be regarded as departure from the spirit and scope of the invention, and all such modifications as would be obvious to one skilled in the art are intended to be included within the scope of the following claims:

1. An apparatus, comprising:
one or more processors; and
a computer-readable medium coupled to said one or more processors having instructions stored thereon that, when executed by said one or more processors, cause said one or more processors to perform operations comprising:
receiving a request for an advertisement from a client device, said advertisement request including encrypted information comprising a location of said client device and data indicating an identity of a user associated with the client device;
decrypting the encrypted information to determine the location of the client device and the data indicating the identity of the user associated with the client device;
accessing one or more tables containing data that associates advertisements, recommendations of the advertisements, identities of users associated with the recommendations of the advertisements, and locations at which the users associated with the recommendations of the advertisements made the recommendations of the advertisements;
determining, for each of a plurality of candidate advertisements, a location at which a contact of the user associated with the client device made a recommendation of the candidate advertisement;
selecting one of the candidate advertisements based on a comparison of the locations at which the contacts of the user made the recommendations of the candidate advertisements and the location of the user device; and
serving the selected candidate advertisement to said client device.

2. The apparatus of claim 1, wherein said computer-readable medium coupled to said one or more processors has further instructions stored thereon that, when executed by said one or more processors, cause said one or more processors to perform operations further comprising:
generating an annotation for the selected candidate advertisement based on the data contained in the one or more tables, wherein the annotation includes a name of the contact of the user who made the recommendation of the candidate advertisement; and
serving the annotation to the client device in conjunction with the selected candidate advertisement.

3. The apparatus of claim 1, wherein said computer-readable medium coupled to said one or more processors has further instructions stored thereon that, when executed by said one or more processors, cause said one or more processors to perform operations further comprising:
maintaining an index of location records sorted by distance to said location of the client device;
determining, from said index, an index value indicating a location record associated with said location of the client device; and
retrieving said location record from said location table based on said index value.

4. The apparatus of claim 1, wherein said computer-readable medium coupled to said one or more processors has further instructions stored thereon that, when executed by said one or more processors, cause said one or more processors to perform operations further comprising:
computing distances between each of the locations at which the contacts of the user made the recommendations of the candidate advertisements and the location of the user device; and
selecting the one of the candidate advertisements based on a comparison of the computed distances.

5. The apparatus of claim 1, wherein the determination, for each of the plurality of candidate advertisements, of a location at which a contact of the user associated with the client device made a recommendation of the candidate advertisement is based on the data contained in the one or more tables.

6. The apparatus of claim 1, wherein said computer-readable medium coupled to said one or more processors has further instructions stored thereon that, when executed by said one or more processors, cause said one or more processors to perform operations further comprising:
updating an ad score for each of the plurality of candidate advertisements based on the comparison of the location at which the contact of the user made the recommendation of the candidate advertisement and the location of the user device; and
serving to the client device one of the candidate advertisements having a highest updated ad score.

7. The apparatus of claim 1, wherein said computer-readable medium coupled to said one or more processors has further instructions stored thereon that, when executed by said one or more processors, cause said one or more processors to perform operations further comprising:
determining, for each of a plurality of candidate advertisements, a level of interaction between the user associated with the client device and a contact of the user who made a recommendation of the candidate advertisement;
selecting one of the candidate advertisements based on a comparison of the levels of interaction between the user associated with the client device and the contacts of the user who made the recommendations of the candidate advertisements; and
serving the selected candidate advertisement to the client device.

8. The apparatus of claim 7, wherein said computer-readable medium coupled to said one or more processors has further instructions stored thereon that, when executed by said one or more processors, cause said one or more processors to perform operations further comprising:
updating an ad score for each of the plurality of candidate advertisements based on the comparison of the levels of interaction between the user associated with the client device and the contacts of the user who made the recommendations of the candidate advertisements; and
serving to the client device one of the candidate advertisements having a highest updated ad score.

9. The apparatus of claim 1, wherein said one or more tables include at least one of a recommendation data table, a social data table, and a location data table;
wherein said recommendation data table includes at least user ID, ad ID, and timestamp information;
wherein said social data table includes at least user ID, contact ID, and weight information; and
wherein said location data table includes at least user ID, location, and timestamp information.

10. The apparatus of claim 1, wherein the selection of one of the candidate advertisements is based on a comparison of the location at which the contacts of the user made the recommendations of the candidate advertisements, and also a comparison of levels of interaction between the user associated with the client device and the contacts of the user who made the recommendations of the candidate advertisement.

11. The apparatus of claim 10, wherein each of the levels of interaction is determined based on a frequency of interactions between the user associated with the client device and the contact of the user who made the recommendation of the candidate advertisement, a volume of interactions between the user associated with the client device and the contact of the user who made the recommendation of the candidate advertisement, or both.

12. A method performed by a data processing apparatus, the method comprising:
receiving a request for an advertisement from a client device, said advertisement request including encrypted information comprising a location of said client device and data indicating an identity of a user associated with the client device;
decrypting the encrypted information to determine the location of the client device and the data indicating the identity of the user associated with the client device;
accessing one or more tables containing data that associates advertisements, recommendations of the advertisements, identities of users associated with the recommendations of the advertisements, and locations at which the users associated with the recommendations of the advertisements made the recommendations of the advertisements;
determining, for each of a plurality of candidate advertisements, a location at which a contact of the user associated with the client device made a recommendation of the candidate advertisement;
selecting one of the candidate advertisements based on a comparison of the locations at which the contacts of the user made the recommendations of the candidate advertisements and the location of the user device; and
serving the selected candidate advertisement to said client device.

13. The method of claim 12, further comprising:
generating an annotation for the selected candidate advertisement based on the data contained in the one or more tables, wherein the annotation includes a name of the contact of the user who made the recommendation of the candidate advertisement; and
serving the annotation to the client device in conjunction with the selected candidate advertisement.

14. The method of claim 12, further comprising:
maintaining an index of location records sorted by distance to said location of the client device;
determining, from said index, an index value indicating a location record associated with said location of the client device; and
retrieving said location record from said location table based on said index value.

15. The method of claim 12, further comprising:
computing distances between each of the locations at which the contacts of the user made the recommendations of the candidate advertisements and the location of the user device; and
selecting the one of the candidate advertisements based on a comparison of the computed distances.

16. The method of claim 12, wherein the determination, for each of the plurality of candidate advertisements, of a location at which a contact of the user associated with the client device made a recommendation of the candidate advertisement is based on the data contained in the one or more tables.

17. The method of claim 12, further comprising:
updating an ad score for each of the plurality of candidate advertisements based on the comparison of the location at which the contact of the user made the commendation of the candidate advertisement and the location of the user device; and
serving to the client device one of the candidate advertisements having a highest updated ad score.

18. The method of claim 12, further comprising: further comprising:
determining, for each of a plurality of candidate advertisements, a level of interaction between the user associated with the client device and a contact of the user who made a recommendation of the candidate advertisement;
selecting one of the candidate advertisements based on a comparison of the levels of interaction between the user associated with the client device and the contacts of the user who made the recommendations of the candidate advertisements; and
serving the selected candidate advertisement to the client device.

19. The method of claim 18, further comprising:
updating an ad score for each of the plurality of candidate advertisements based on the comparison of the levels of interaction between the user associated with the client device and the contacts of the user who made the recommendations of the candidate advertisements; and
serving to the client device one of the candidate advertisements having a highest updated ad score.

20. The method of claim 12, wherein said one or more tables include at least one of a recommendation data table, a social data table, and a location data table;
wherein said recommendation data table includes at least user ID, ad ID, and timestamp information;
wherein said social data table includes at least user ID, contact ID, and weight information; and
wherein said location data table includes at least user ID, location, and timestamp information.

21. The method of claim 12, wherein the selection of one of the candidate advertisements is based on a comparison of the locations at which the contacts of the user made the recommendations of the candidate advertisements, and also a comparison of levels of interaction between the user associated with the client device and the contacts of the user who made the recommendations of the candidate advertisements.

22. The method of claim 21, wherein each of the levels of interaction is determined based on a frequency of interactions between the user associated with the client device and the contact of the user who made the recommendation of the candidate advertisement, a volume of interactions between the user associated with the client device and the contact of the user who made the recommendation of the candidate advertisement, or both.

23. A non-transitory computer readable medium coupled to one or more processors having instructions stored thereon that, when executed by said one or more processors, causes said one or more processors to perform operations comprising:
receiving a request for an advertisement from a client device, said advertisement request comprising encrypted information including a location of said client device and data indicating an identity of a user associated with the client device;
decrypting the encrypted information to determine the location of the client device and the data indicating the identity of the user associated with the client device;
accessing one or more tables containing data that associates advertisements, recommendations of the advertisements, identities of users associated with the recommendations of the advertisements, and locations at which the users associated with the recommendations of the advertisements made the recommendations of the advertisements;
determining, for each of a plurality of candidate advertisements, a location at which a contact of the user associated with the client device made a recommendation of the candidate advertisement;
selecting one of the candidate advertisements based on a comparison of the locations at which the contacts of the user made the recommendations of the candidate advertisements and the location of the user device; and
serving the selected candidate advertisement to said client device.

24. The computer-readable medium of claim 23, wherein said computer-readable medium coupled to said one or more processors had further instructions stored thereon that, when executed by said one or more processors, cause said one or more processors to perform operations further comprising:
generating an annotation for the selected candidate advertisement based on the data contained in the one or more tables, wherein the annotation includes a name of the contact of the user who made the recommendation of the candidate advertisement; and
serving the annotation to the client device in conjunction with the selected candidate advertisement.

25. The computer-readable medium of claim 23, wherein said computer-readable medium coupled to said one or more processors has further instructions stored thereon that, when executed by said one or more processors, cause said one or more processors to perform operations further comprising:
maintaining an index of location records sorted by distance to said location of the client device;
determining, from said index, an index value indicating a location record associated with said location of the client device; and
retrieving said location record from said location table based on said index value.

26. The computer-readable medium of claim 23, wherein said computer-readable medium coupled to said one or more processors has further instructions stored thereon that, when executed by said one or more processors, cause said one or more processors to perform operations further comprising:
computing distances between each of the locations at which the contacts of the user made the recommendations of the candidate advertisements and the location of the user device; and
selecting the one of the candidate advertisements based on a comparison of the computed distances.

27. The computer-readable medium of claim 23, wherein the determination, for each of the plurality of candidate advertisements, of a location at which a contact of the user associated with the client device made a recommendation of the candidate advertisement is based on the data contained in the one or more tables.

28. The computer-readable medium of claim 23, wherein said computer-readable medium coupled to said one or more processors has further instructions stored thereon that, when executed by said one or more processors, cause said one or more processors to perform operations further comprising:
updating an ad score for each of the plurality of candidate advertisements based on the comparison of the location at which the contact of the user made the recommendation of the candidate advertisement and the location of the user device; and
serving to the client device one of the candidate advertisements having a highest updated ad score.

29. The computer-readable medium of claim 23, wherein said computer-readable medium coupled to said one or more processors has further instructions stored thereon that, when executed by said one or more processors, cause said one or more processors to perform operations further comprising:
determining, for each of a plurality of candidate advertisements, a level of interaction between the user associated with the client device and a contact of the user who made a recommendation of the candidate advertisement;
selecting one of the candidate advertisements based on a comparison of the levels of interaction between the user associated with the client device and the contacts of the user who made the recommendations of the candidate advertisements; and
serving the selected candidate advertisement to the client device.

30. The computer-readable medium of claim 29, wherein said computer-readable medium coupled to said one or more processors has further instructions stored thereon that, when executed by said one or more processors, cause said one or more processors to perform operations further comprising:
updating an ad score for each of the plurality of candidate advertisements based on the comparison of the levels of interaction between the user associated with the client device and the contacts of the user who made the recommendations of the candidate advertisements; and serving to the client device one of the candidate advertisements having a highest updated ad score.

31. The computer-readable medium of claim 23, wherein said one or more tables include at least one of a recommendation data table, a social data table, and a location data table;
wherein said recommendation data table includes at least user ID, ad ID, and timestamp information;
wherein said social data table includes at least user ID, contact ID, and weight information; and
wherein said location data table includes at least user ID, location, and timestamp information.

32. The computer-readable medium of claim 23, wherein the selection of one of the candidate advertisements is based on a comparison of the locations at which the contacts of the user made the recommendations of the candidate advertisements, and also a comparison of levels of interaction between the user associated with the client device and the contacts of the user who made the recommendations of the candidate advertisements.

33. The computer-readable medium of claim 32, wherein each of the levels of interaction is determined based on a frequency of interactions between the user associated with the client device and the contact of the user who made the recommendation of the candidate advertisement, a volume of interactions between the user associated with the client device and the contact of the user who made the recommendation of the candidate advertisement, or both.

34. A method performed by a data processing apparatus, the method comprising:
receiving a request for an advertisement form a client device, said advertisement request comprising encrypted information including a location of said client device and encrypted data indicating an identity of a user associated with the client device;
decrypting the encrypted information to determine the location of the client device and the encrypted data indicating the identity of the user associated with the client device to determine the identity of the user associated with the client device;
accessing one or more tables containing data that associates advertisements, recommendations of the advertisements, and locations at which the users associated with the recommendations of the advertisements made the recommendations of the advertisements;
determining, for each of a plurality of candidate advertisements, a level of interaction between the user associated with the client device and a contact of the user who made a recommendation of the candidate advertisement;
selecting one of the candidate advertisements based on a comparison of the levels of interaction between the user associated with the client device and the contacts of the user who made the recommendations of the candidate advertisements and further based on a comparison of the locations at which the contacts of the user made the recommendations of the candidate advertisements and the location of the user device; and
serving the selected candidate advertisement to said client device.

35. An apparatus, comprising:
one or more processors; and
a computer-readable medium coupled to said one or more processors having instructions stored thereon that, when executed by said one or more processors, cause said one or more processors to perform operations comprising:
presenting an advertisement to a user of said apparatus;
receiving an indication that the user recommended the presented advertisement, wherein the received indication includes encrypted data identifying a location at which the user recommended the advertisement;
decrypting the encrypted information to determine the location at which the user recommended the advertisement;
logging, in one or more tables, data indicating that the user recommended the advertisement, the location at which the user recommended the advertisement, an identity of the user who recommended the advertisement, and an identifier for the advertisement recommended by the user;
in response to determining that a location of a contact of the user corresponds to the location at which the user recommended the advertisement, sending the advertisement to a device associated with the contact of the user, wherein the advertisement is sent in conjunction with an annotation indicating the identity of the user and indicating that the user recommended the advertisement.

36. A non-transitory computer-readable medium coupled to one or more processors having instructions stored thereon that, when executed by said one or more processors, cause said one or more processors to perform operations comprising:
presenting an advertisement to a user;
receiving an indication that the user recommended the presented advertisement, wherein the received indication includes encrypted data identifying a location at which the user recommended the advertisement;
decrypting the encrypted data to determine the location at which the user recommended the advertisement;
logging, in one or more tables, data indicating that the user recommended the advertisement, the location at which the advertisement, and an identifier for the advertisement recommended by the user; and
in response to determining that a location of a contact of the user corresponds to the location at which the user recommended the advertisement, sending the advertisement to a device associated with the contact of the user, wherein the advertisement is sent in conjunction with an annotation indicating the identity of the user and indicating that the user recommended the advertisement.
